(19) United States
(12) Patent Application Publication
(10) Pub. No.: US 2022/0403217 A1
(43) Pub. Date: Dec. 22, 2022

(54) PREPARATION OF PRESSURE SENSITIVE ADHESIVES FROM POST-CONSUMER SUPERABSORBENT POLYMERS

(71) Applicant: The Regents of the University of Michigan, Ann Arbor, MI (US)

(72) Inventors: Paul Takunda Chazovachii, Ann Arbor, MI (US); Anne J. McNeil, Ann Arbor, MI (US); Madeline Somers, Ann Arbor, MI (US); Jose Alfaro, Ann Arbor, MI (US)

(21) Appl. No.: 17/719,908

(22) Filed: Apr. 13, 2022

Related U.S. Application Data
(60) Provisional application No. 63/217,734, filed on Jul. 1, 2021.
(60) Provisional application No. 63/174,400, filed on Apr. 13, 2021.

(51) Int. Cl. C09J 133/02; C08F 8/12; C08F 8/14; C08F 20/06; C08J 11/04

(52) U.S. Cl. CPC C09J 133/02; C08F 8/12; C08F 8/14; C08F 20/06; C08J 11/04; C08J 2333/02

(57) ABSTRACT

Methods, including a one-step synthesis method, for chemically modifying crosslinked sodium polyacrylate to form pressure sensitive adhesives are disclosed.

### STATEMENT OF RELATED APPLICATIONS

This application claims priority to U.S. Provisional Patent Application No. 63/174,400, filed Apr. 13, 2021, and U.S. Provisional Patent Application No. 63/217,734, filed Jul. 1, 2021, the entire contents of which are incorporated herein by reference for all purposes.

### BACKGROUND

Commercial polymers are ubiquitous, with a global annual production of approximately 368 million metric tons. Statistica.com, 2020. They also are unsustainable because their feedstocks currently come from nonrenewable resources. Geyer et al., 2017. In addition, approximately 75% of plastics are disposed of after a single use. Advancing Sustainable Materials Management, 2017 fact sheet (EPA 530-F-19-007). Although durability and strength are advantages of synthetic polymers, these properties also are responsible for their environmental persistence. Plastics and the Environment, 2003; Rachman, 2018; Barnes et al., 2009. The synthetic polymer community created these impactful materials, and now, must turn their attention towards a more sustainable approach. Fagnani et al., 2021.

### SUMMARY

In some aspects, the presently disclosed subject matter provides a method for converting a sodium polyacrylate to a pressure sensitive adhesive, the method comprising: (a) acid-catalyzed or base-mediated decrosslinking the polyacrylate via hydrolysis to generate a linear polymer; (b) optionally sonicating the linear polymer to lower a molar mass thereof; and (c) functionalizing the linear polymer via esterification to generate a pressure sensitive adhesive.

In some aspects, the sodium polyacrylate comprises a sodium poly(acrylate) crosslinked via a poly(ethylene glycol) diacrylate co-monomer. In particular aspects, the one or more sodium polyacrylate-based superabsorbent polymers are derived from a disposable personal hygiene product. In more particular aspects, the disposable personal hygiene product is selected from the group consisting of a baby diaper, an adult incontinence product, and a feminine hygiene product.

In some aspects, the base-mediated decrosslinking via hydrolysis step includes contacting the sodium polyacrylate with NaOH under heating for a period of time.

In some aspects, the acid-catalyzed decrosslinking via hydrolysis step includes contacting the sodium polyacrylate with H₂SO₄ under heating for a period of time.

In some aspects, the linear polymer is sonicated to a MA of between about 300 kg/mol to about 400 kg/mol, including 300, 310, 320, 330, 340, 350, 360, 370, 380, 390, and 400 kg/mol.

In some aspects, the method further comprises dialyzing the sonicated linear polymer. In some aspects, the method further comprises lyophilizing the dialyzed linear polymer. In some aspects, the method further comprises grinding the lyophilized linear polymer.

In some aspects, the functionalizing of the linear polymer via esterification includes contacting the polyacrylate with an alkyl alcohol in the presence of an acid catalyst.

In certain aspects, the alkyl alcohol is 2-ethylhexanol. In certain aspects, the acid is sulfuric acid.

In other aspects, the presently disclosed subject matter provides a one-pot synthesis method for converting a sodium polyacrylate to a pressure sensitive adhesive, the method comprising: (a) disposing an alkyl alcohol and a sodium polyacrylate into a reaction vessel to form a first reaction mixture; (b) adding a protic solvent and an acid to the reaction vessel to form a second reaction mixture; (c) heating the second reaction mixture with stirring to form a polymer comprising a pressure sensitive adhesive.

In some aspects, the method further comprises bubbling an inert gas through the first reaction mixture and/or the second reaction mixture for a period of time to remove oxygen from the reaction vessel. In particular aspects, the inert gas comprises nitrogen.

In certain aspects, the protic solvent is water or a hydrophilic alcohol. In particular aspects, the hydrophilic alcohol is methanol or ethanol.

In certain aspects, the alkyl alcohol is 2-ethylhexanol or butyl alcohol.

In some aspects, the method further comprises cooling the reaction vessel. In some aspects, the method further comprises isolating the polymer comprising the pressure sensitive adhesive by precipitating into an alcohol. In some aspects, the method further comprises centrifugation of the precipitate.

In some aspects, the method further comprises removing one or more byproducts. In some aspects, the method further comprises purifying by dissolving/swelling the polymer comprising the pressure sensitive adhesive in tetrahydrofuran (THF) and precipitating with methanol and drying under vacuum.

In some aspects, the sodium polyacrylate comprises a sodium poly(acrylate) crosslinked via a poly(ethylene glycol) diacrylate co-monomer. In particular aspects, the one or more sodium polyacrylate-based superabsorbent polymers are derived from a disposable personal hygiene product. In more particular aspects, the disposable personal hygiene product is selected from the group consisting of a baby diaper, an adult incontinence product, and a feminine hygiene product.

In some aspects, the presently disclosed subject matter provides an article comprising pressure sensitive adhesive formed by the presently disclosed methods. In some aspects, the article is selected from the group consisting of pressure sensitive tape, a bandage, a label, note pads, a decal, a stamp, an envelope, a sticker, packaging, automobile trim, and a film.

Certain aspects of the presently disclosed subject matter having been stated hereinabove, which are addressed in whole or in part by the presently disclosed subject matter, other aspects will become evident as the description proceeds when taken in connection with the accompanying Examples and Figures as best described herein below.

### BRIEF DESCRIPTION OF THE FIGURES

The patent or application file contains at least one figure executed in color. Copies of this patent or patent application publication with color figures will be provided by the Office upon request and payment of the necessary fee.

Having thus described the presently disclosed subject matter in general terms, reference will now be made to the accompanying Figures, which are not necessarily drawn to scale, and wherein.

FIG. 1 is a plot of weight-average molar mass (M_{w}) and maximum specific energy (w) versus time for sonicating PAA_{P&G} at 2.5% w/v (left) and 5.0% w/v (right);

FIG. 2 shows plots of storage (G′) versus loss (G″) moduli for P(2-EHA)P&G (left), including visualization of Chang's viscoelastic window;

FIG. 3 shows frequency sweep data for decrosslinking PAA_{P&G} (5% w/v) using 0.3 M aq. NaOH at 80° C.;

FIG. 4 shows frequency sweep data for decrosslinking PAA_{P&G} (5% w/v) using 0.8 M aq. H₂SO₄ at 120° C.;

FIG. 5 compares the cumulative energy demand and global warming potential for sulfuric acid versus sodium hydroxide using data from the SimaPro database;

FIG. 6 shows SEC traces for the chain-shortening of decrosslinked PAA_{P&G} at 5.0% w/v;

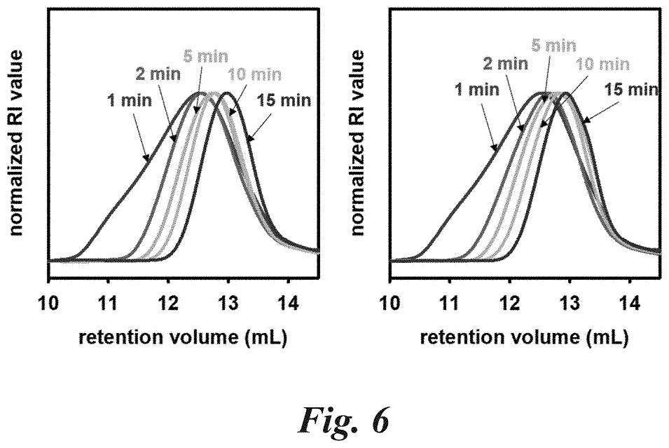

FIG. 7 shows the weight average molecular weight (M_{w}) and maximum specific energy (wₘₐₓ) versus time plot for PAA_{P&G} sonication at 5% w/v;

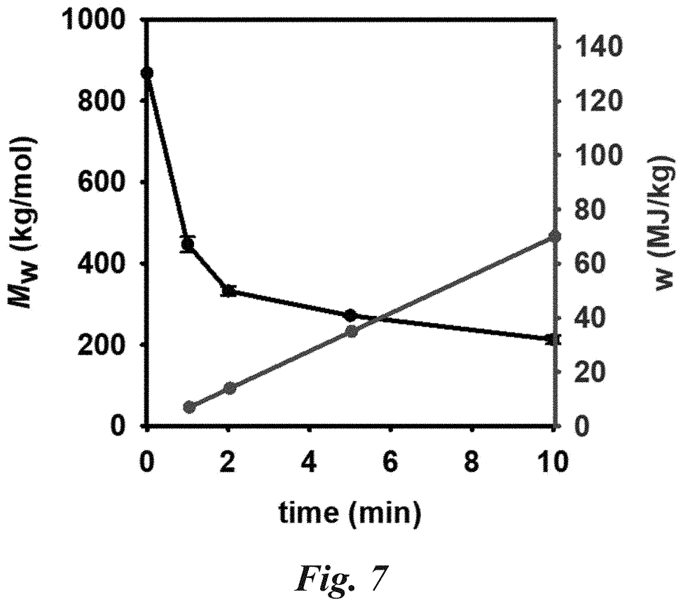

FIG. 8 shows SEC traces for the chain-shortening of decrosslinked PAA_{P&G} at 2.5% w/v;

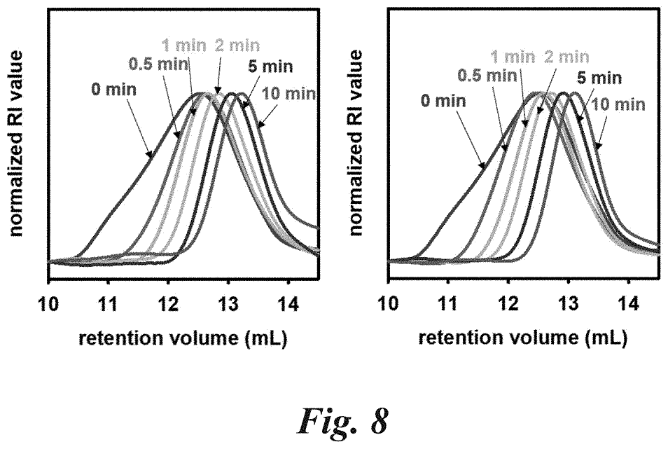

FIG. 9 shows the weight average molecular weight (M_{w}) and maximum specific energy (wₘₐₓ) versus time plot for PAA_{P&G} sonication at 2.5% w/v;

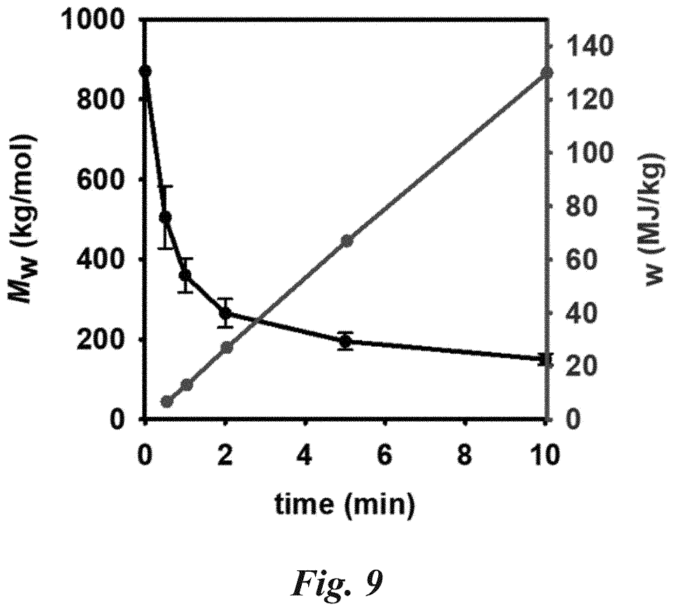

FIG. 10 shows the reaction scheme for the samples shown in FIG. 11;

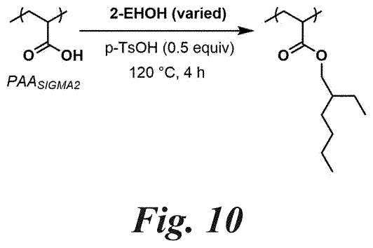

FIG. 11 shows esterification reactions for 3-15 equiv. 2-ethylhexanol: before (left) and after (right) heating to 120° C. for 3-5 h;

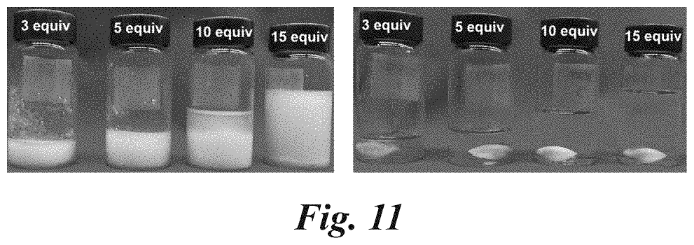

FIG. 12 shows ¹H NMR spectra of P(2-EHA)_{SIGMA1} made from 3-15 equiv. alcohol (500 MHz, CDCl₃);

FIG. 13 shows the IR spectra of P(2-EHA)_{SIGMA1} made from 3-15 equiv. alcohol;

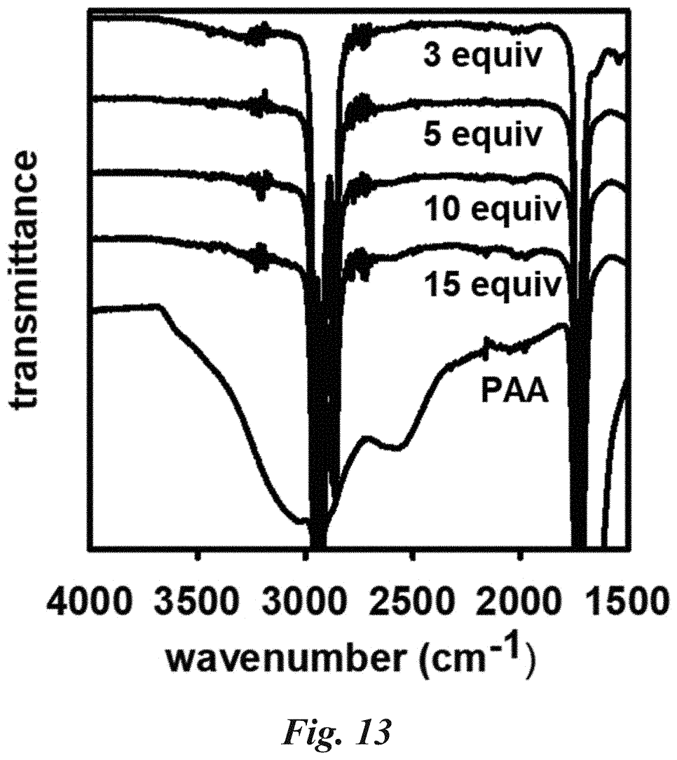

FIG. 14 is an ¹H NMR spectra of P(2-EHA)SPP-20 min (500 MHz, CDCl₃);

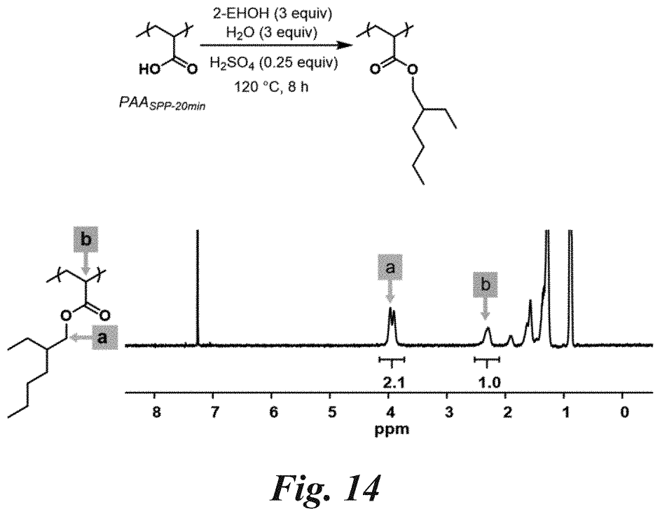

FIG. 15 shows ¹H NMR spectra of acetic acid esterification with 2-ethylhexanol in the presence (middle) and absence (top) of water (500 MHz, CDCl₃/pyridine-d₅ at 2:1);

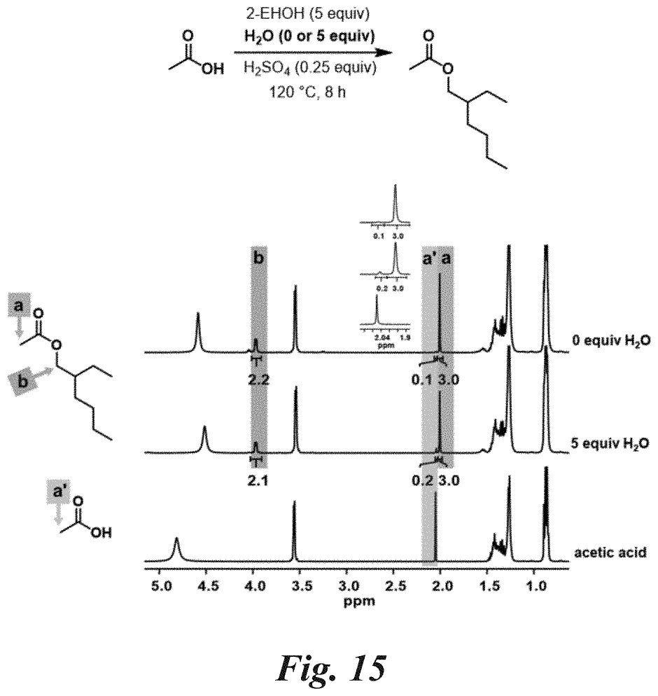

FIG. 16 shows ¹H NMR spectra of acetic acid esterification with 2-ethylhexanol in the presence (middle) and absence (top) of water (500 MHz, CDCl₃/pyridine-d₅ at 2:1);

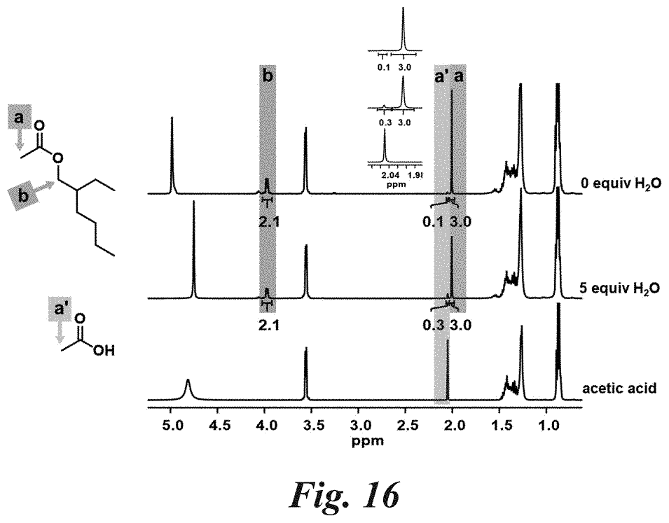

FIG. 17 shows ¹H NMR spectra of decanoic acid esterification with 2-ethylhexanol in the presence (middle) and absence (top) of water (500 MHz, CDCl₃/pyridine-d₅ at 2:1);

FIG. 18 shows ¹H NMR spectra of acetic acid esterification with EtOH in the presence (middle) and absence (top) of water (500 MHz, CDCl₃/pyridine-d₅ at 2:1);

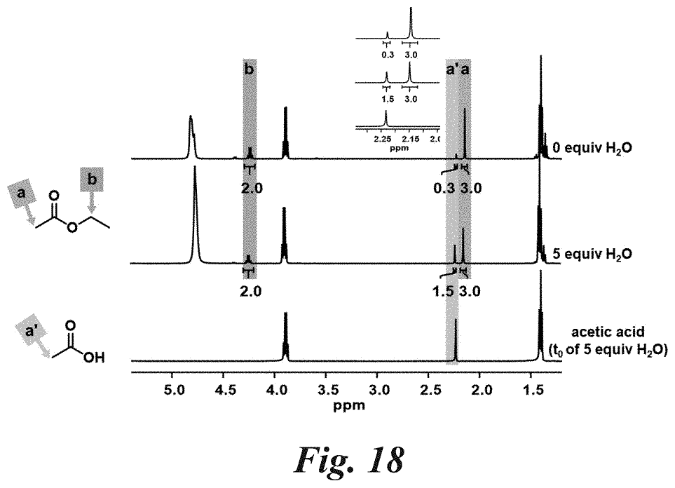

FIG. 19 shows ¹H NMR spectra of undecanoic acid esterification with 2-ethylhexanol in the presence (middle) and absence (top) of water (500 MHz, CDCl₃/pyridine-d₅ at 2:1);

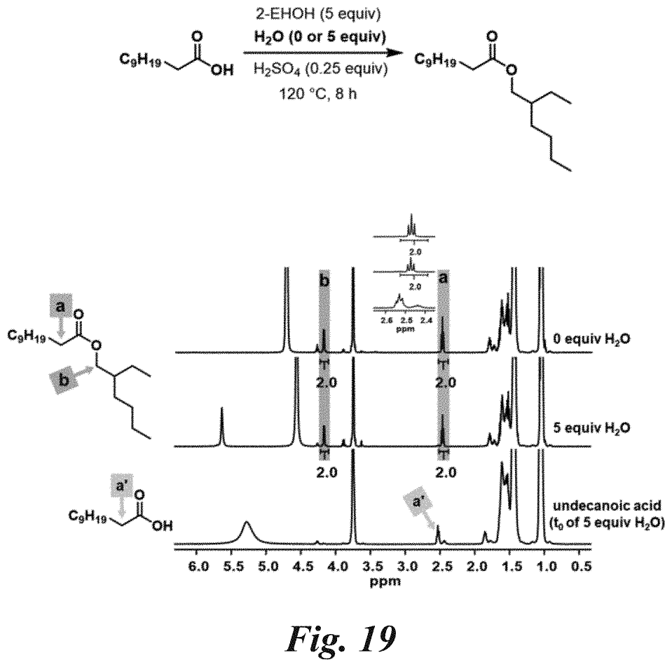

FIG. 20 shows ¹H NMR spectra of decanoic acid esterification with 2-ethylhexanol in the presence (middle) and absence (top) of water (500 MHz, CDCl₃/pyridine-d at 2:1);

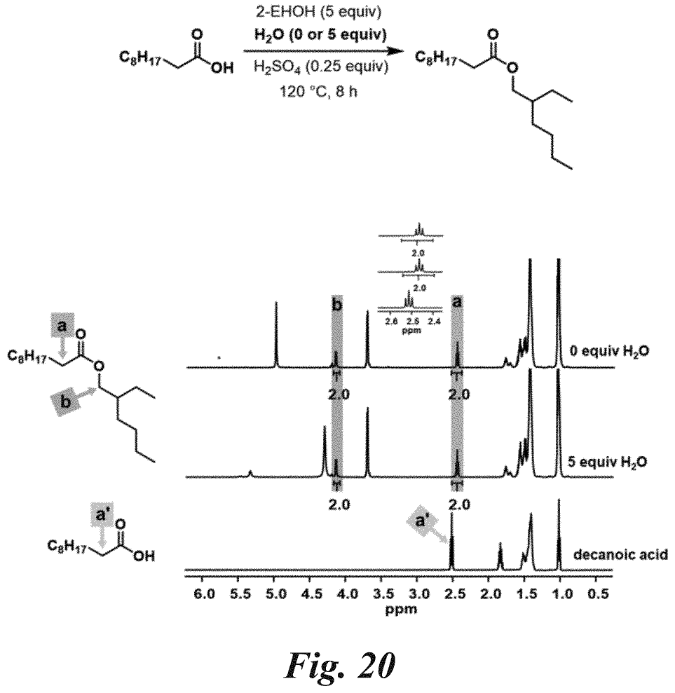

FIG. 21 shows ¹H NMR spectra of undecanoic acid esterification with ethanol in the presence (middle) and absence (top) of water (500 MHz, CDCl₃/pyridine-d at 2:1);

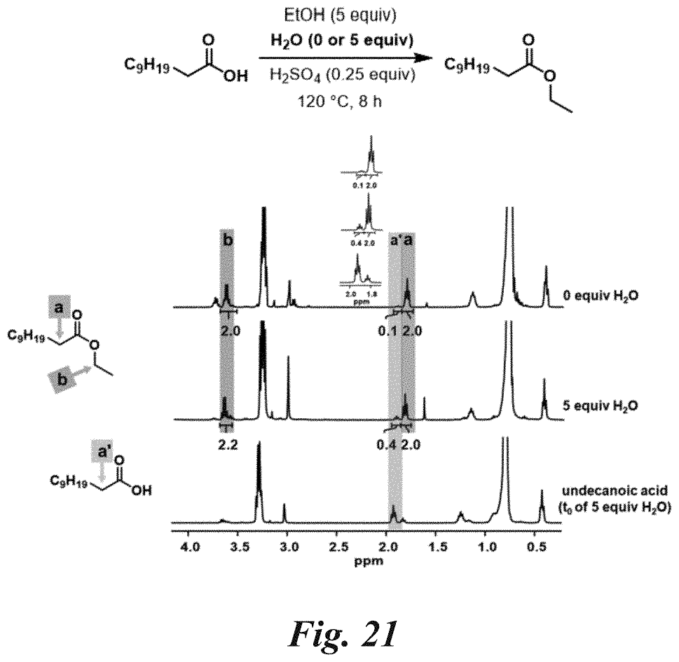

FIG. 22 shows ¹H NMR spectra of undecanoic acid esterification with ethanol in the presence (middle) and absence (top) of water (500 MHz, CDCl₃/pyridine-d₅ at 2:1).

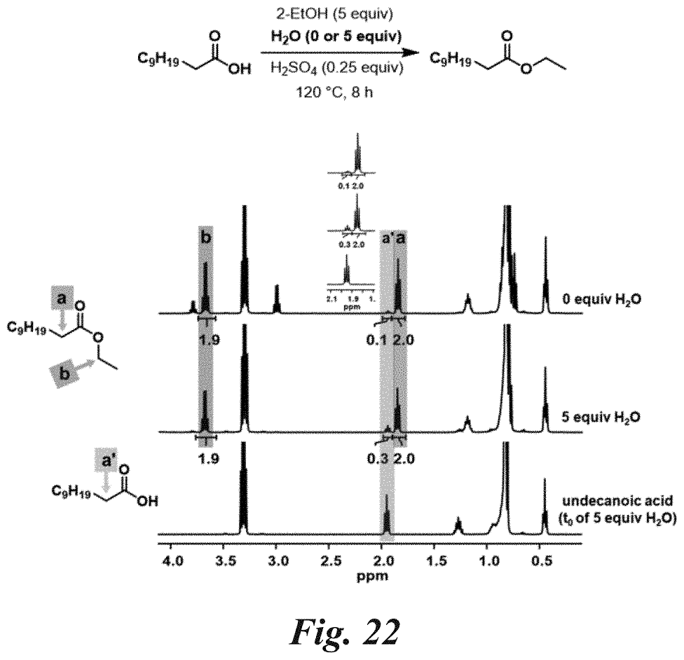

FIG. 23 is the full thermodynamic cycle used to evaluate the free energy of esterification;

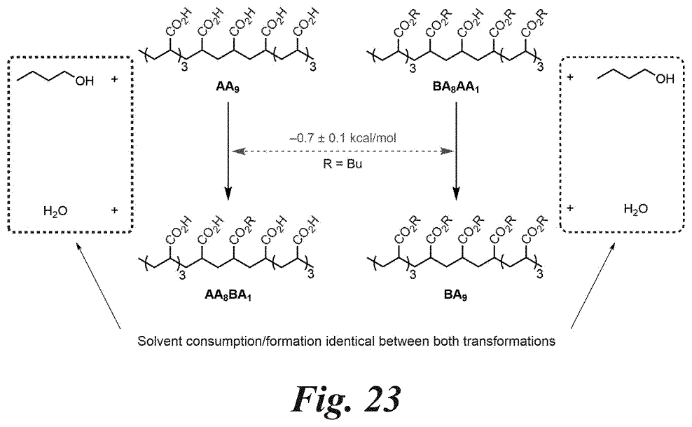

FIG. 24 is an ¹H NMR spectrum for P(2-EHA)_{P&G_5%-0 min} (500 MHz, CDCl₃);

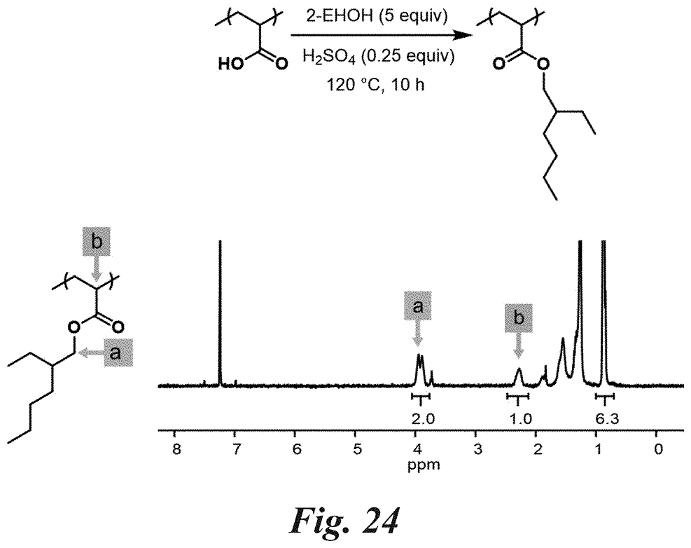

FIG. 25 shows an IR spectrum (top left), SEC trace (top right), and frequency sweep (bottom) of P(2-EHA) esterifying decrosslinked PAA_{P&G_5%-0 min};

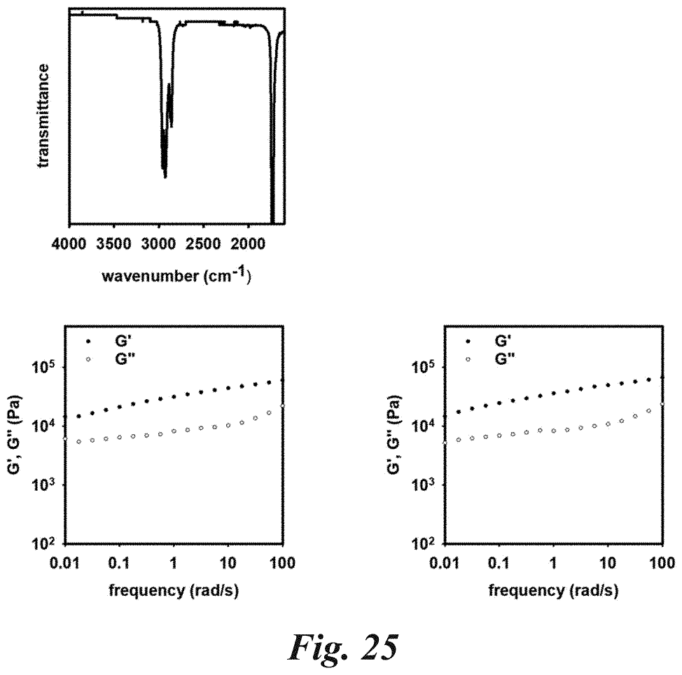

FIG. 26 is an ¹H NMR spectrum for P(2-EHA)_{P&G_5%-2 min} (500 MHz, CDCl₃);

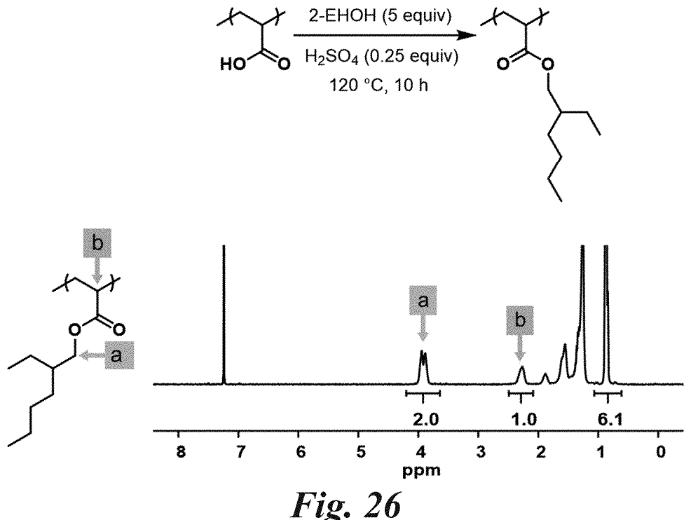

FIG. 27 shows an IR spectrum (top left), SEC trace (top right), and frequency sweep (bottom) of P(2-EHA) esterifying decrosslinked PAA_{P&G_5%-2 min};

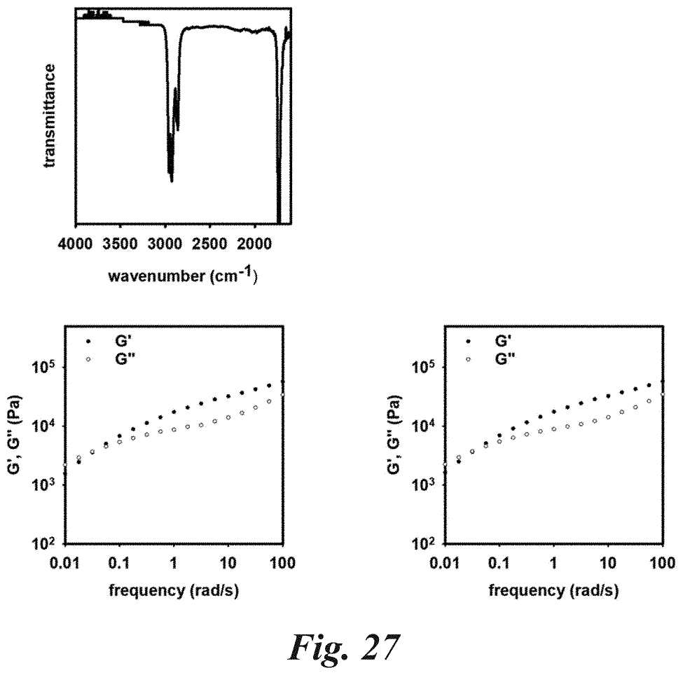

FIG. 28 is an ¹H NMR spectrum for P(2-EHA)_{P&G_5%-5 min} (500 MHz, CDCl₃);

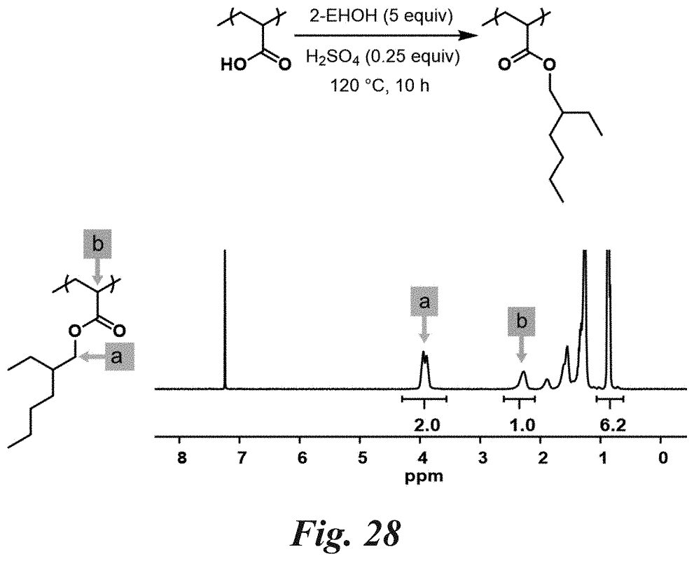

FIG. 29 shows an IR spectrum (top left), SEC trace (top right), and frequency sweep (bottom) of P(2-EHA) esterifying decrosslinked PAA_{P&G_5%-5 min};

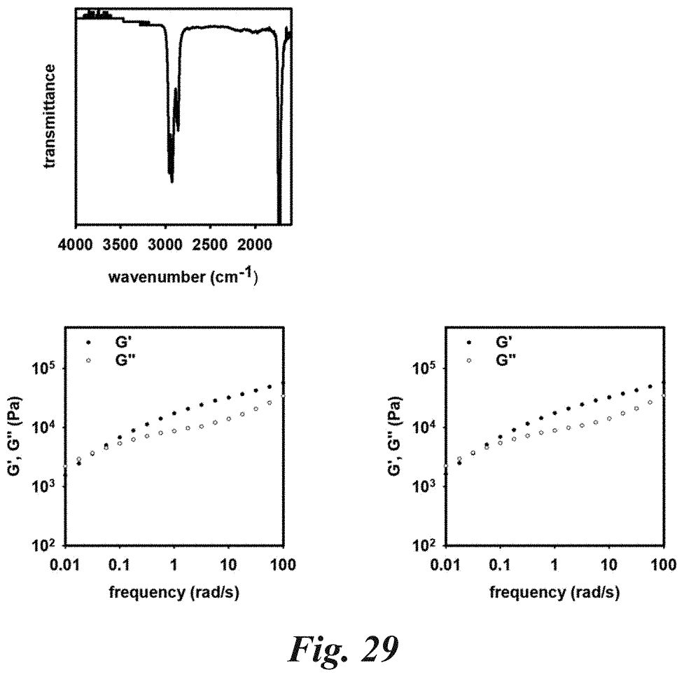

FIG. 30 is an ¹H NMR spectrum for P(2-EHA)_{P&G_2.5%-1 min} (500 MHz, CDCl₃);

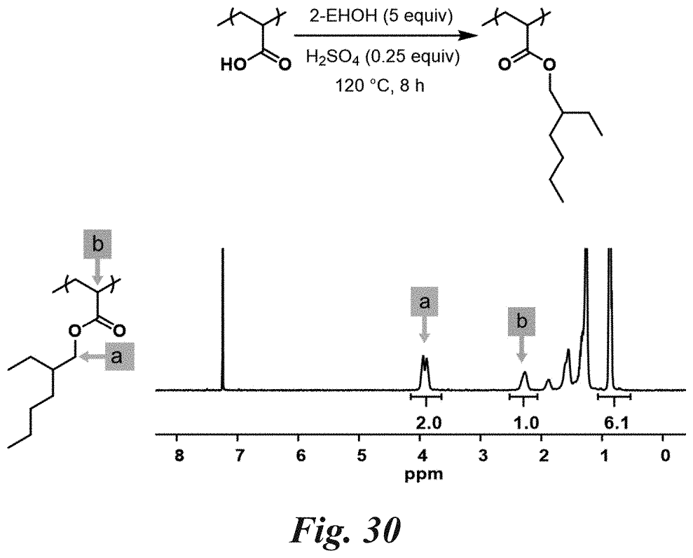

FIG. 31 shows an IR spectrum (top left), SEC trace (top right), and frequency sweep (bottom) of P(2-EHA) esterifying decrosslinked PAA_{P&G_2.5%-1 min};

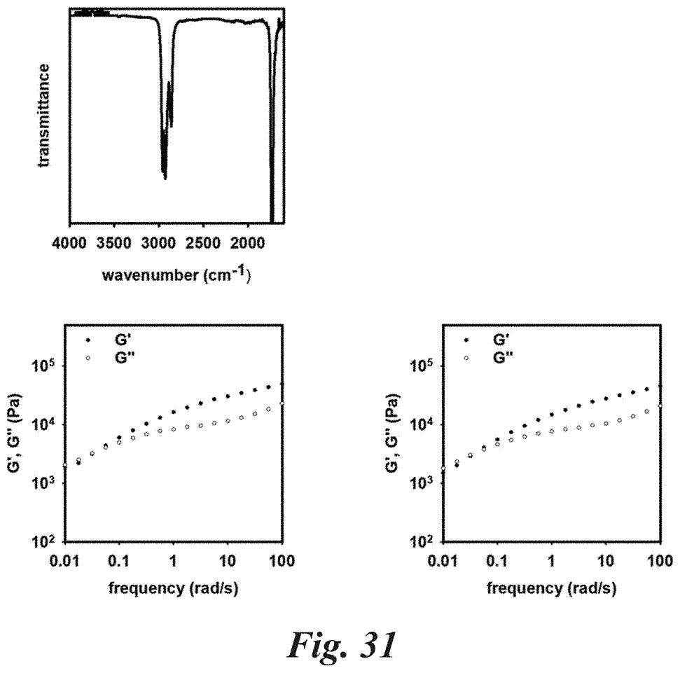

FIG. 32 is an ¹H NMR spectrum for P(2-EHA)_{P&G_5%-0 min} (500 MHz, CDCl₃);

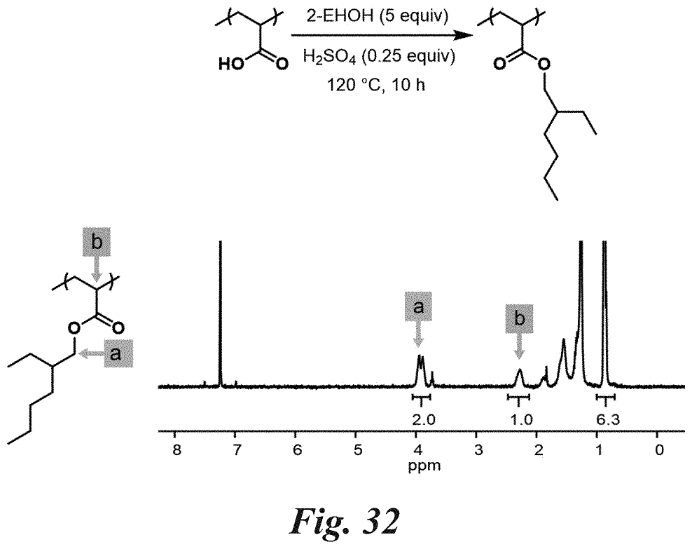

FIG. 33 shows an IR spectrum (top left), SEC trace (top right), and frequency sweep (bottom) of P(2-EHA) esterifying decrosslinked PAA_{P&G_5%-0 min};

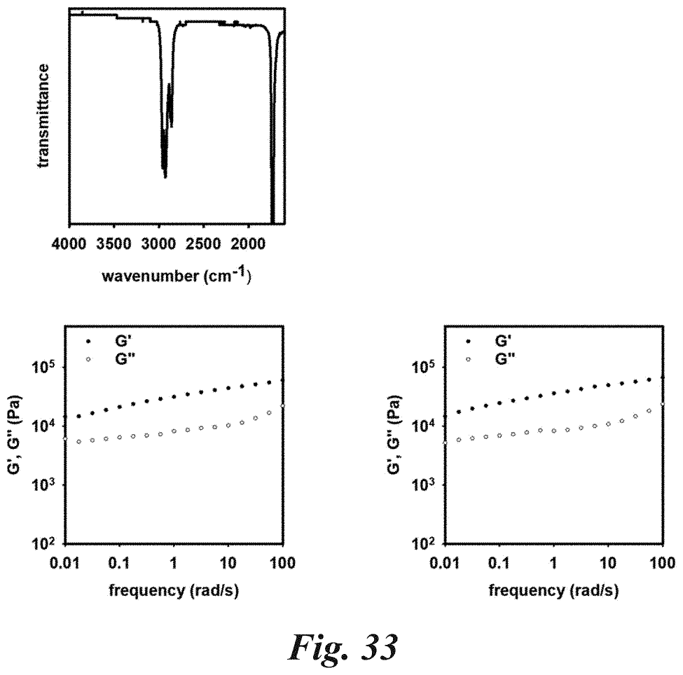

FIG. 34 is an ¹H NMR spectrum for P(2-EHA)_{P&G_5%-2 min} (500 MHz, CDCl₃);

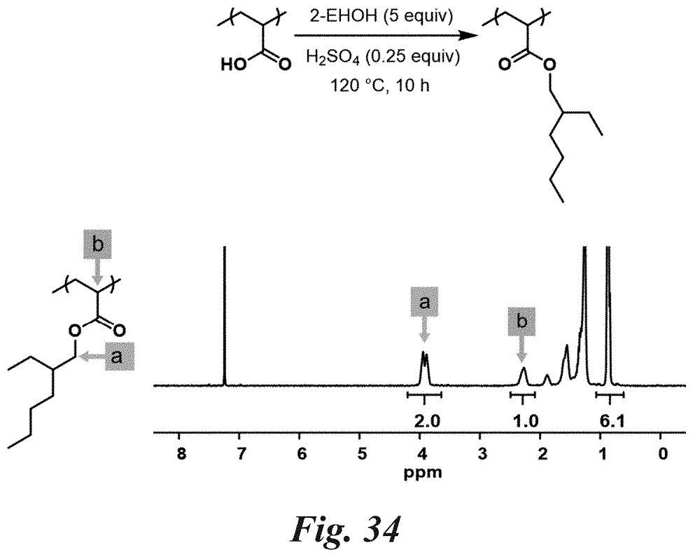

FIG. 35 shows an IR spectrum (top left), SEC trace (top right), and frequency sweep (bottom) of P(2-EHA) esterifying decrosslinked PAA_{P&G_5%-2 min};

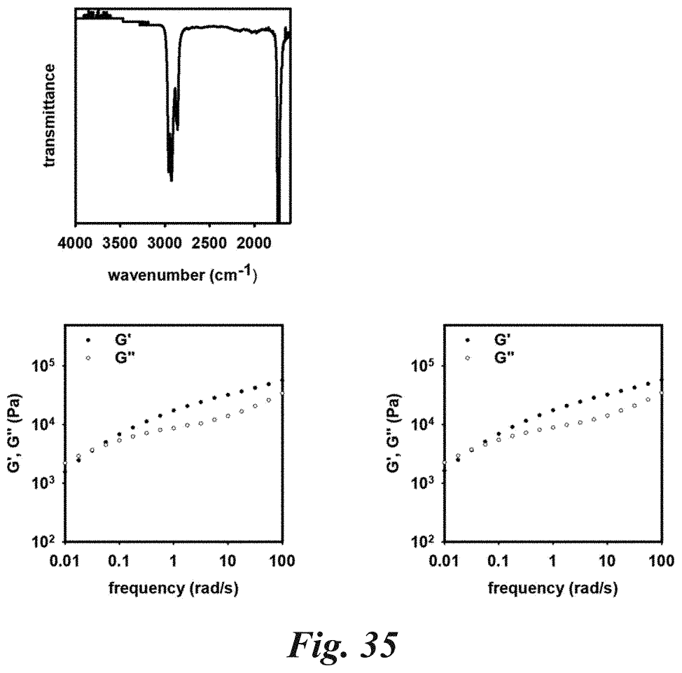

FIG. 36 is an ¹H NMR spectrum for P(2-EHA)_{P&G_5%-5 min} (500 MHz, CDCl₃);

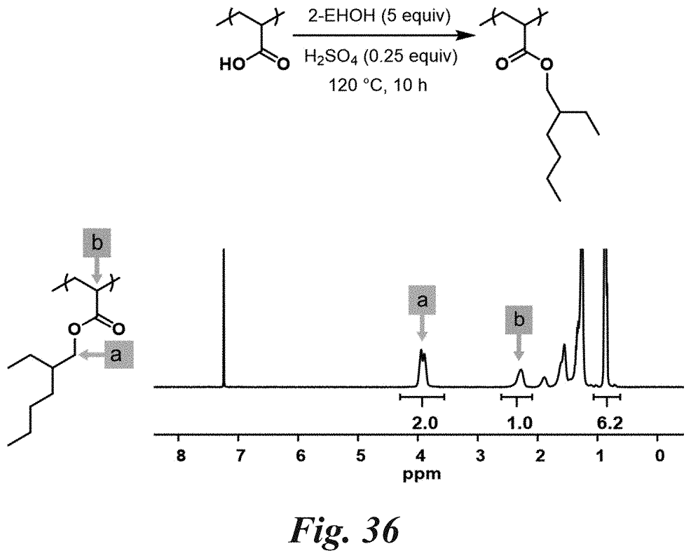

FIG. 37 shows an IR spectrum (top left), SEC trace (top right), and frequency sweep (bottom) of P(2-EHA) esterifying decrosslinked PAA_{P&G_5%-5 min};

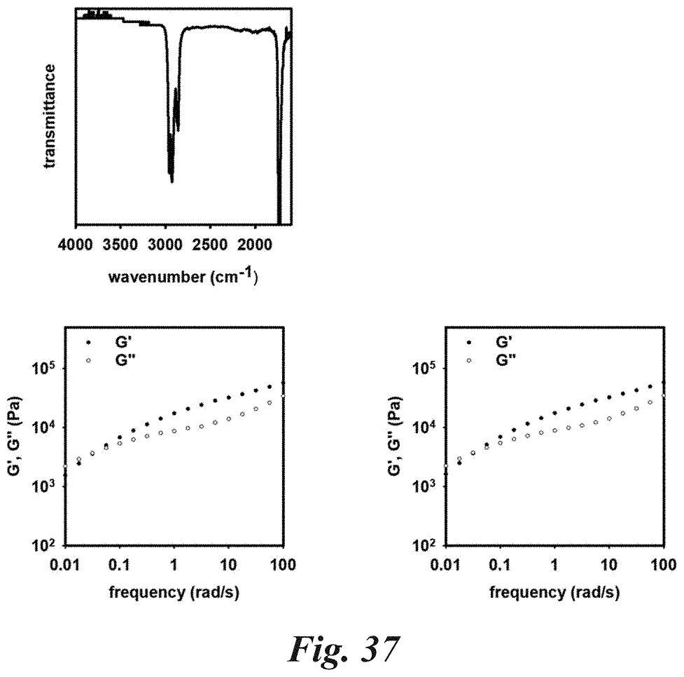

FIG. 38 is an ¹H NMR spectrum for P(2-EHA)_{P&G_2.5%-1 min} (500 MHz, CDCl₃);

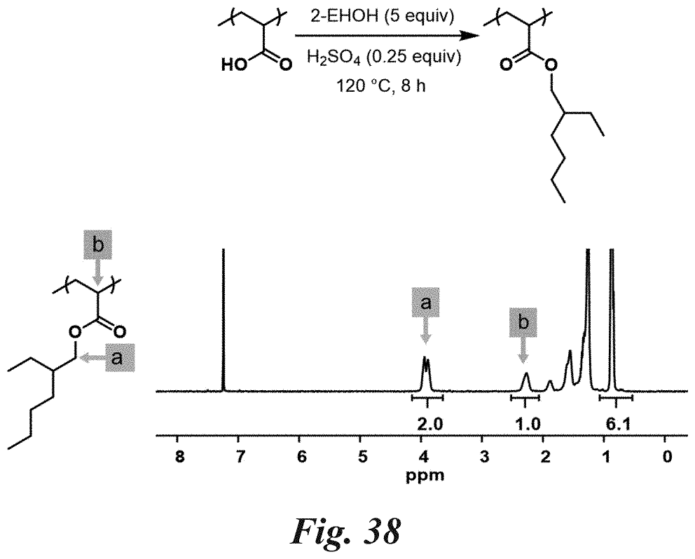

FIG. 39 shows an IR spectrum (top left), SEC trace (top right), and frequency sweep (bottom) of P(2-EHA) esterifying decrosslinked PAA_{P&G_2.5%-1 min};

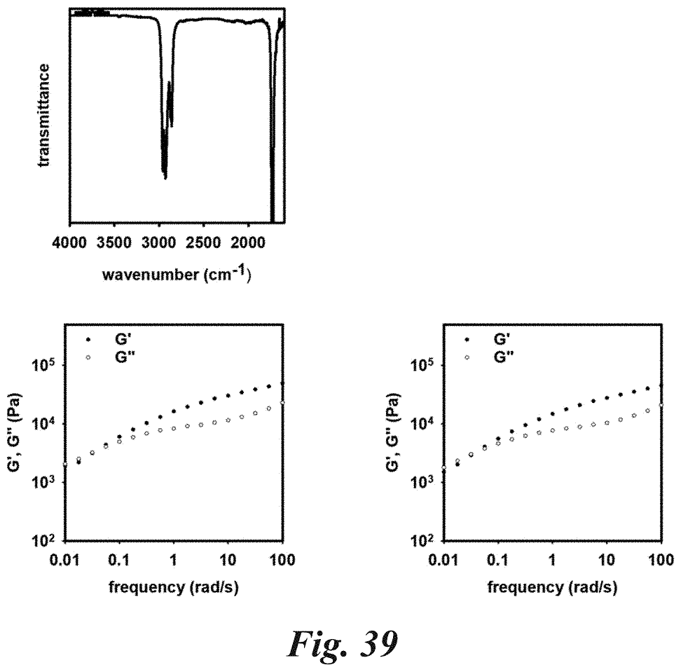

FIG. 40 shows the global warming potential and cumulative energy demand for LCA scenarios;

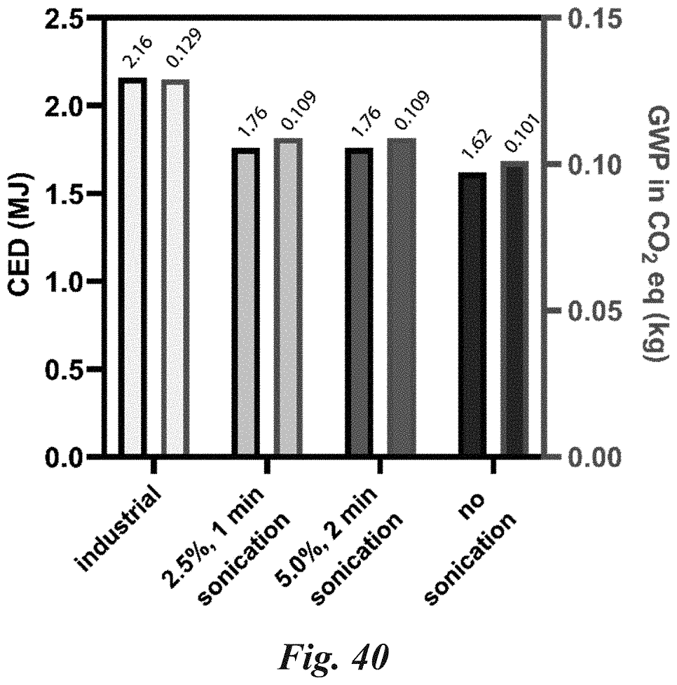

FIG. 41A, FIG. 41B, and FIG. 41C shows a one-pot esterification of PAA_{P&G} to make PSAs. FIG. 41A) Chemical equation for the one-pot esterification method. FIG. 41B) Visual comparing esterifying in the absence (left) versus in the presence (right) of nitrogen and ethanol. FIG. 41C) A scaled-up reaction esterifying 2500 mg of PAA_{P&G} to make PSAs;

FIG. 42 shows plots of storage (G′) versus loss (G″) moduli for esterifying PAA_{P&G} to make adhesives in one-pot, including visualization of Chang's viscoelastic window;

FIG. 43 shows infrared spectra for one-pot esterifications at different timepoints; and

FIG. 44 shows frequency sweeps for one-pot esterifications at different timepoints.

FIG. 45 shows comparing syntheses of pressure-sensitive adhesives from petroleum versus waste diapers as the feedstock.

### DETAILED DESCRIPTION

The presently disclosed subject matter now will be described more fully hereinafter with reference to the accompanying Figures, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Figures. Therefore, it is to be understood that the presently disclosed subject matter is not to be limited to the specific embodiments disclosed and that modifications and other embodiments are intended to be included within the scope of the appended claims.

The presently disclosed subject matter provides a practical method to chemically modify sodium polyacrylate-based superabsorbent polymers (SAP) to form pressure sensitive adhesives (PSAs). As used herein, the term “upcycling,” also known as creative reuse, is the process of transforming by-products, waste materials, useless, or unwanted products into new materials or products of better quality and environmental value. In this instance, both SAP and PSA are used in common consumer products. For example, SAP is used prevalently in various absorbent articles including, but not limited to, diapers and feminine hygiene products. Further, PSAs are used in a variety of articles including, but not limited to, pressure sensitive tape, bandage, labels, note pads, decals, stamps, envelopes, stickers, various packaging, automobile trims, and films.

The SAP described herein is an insoluble, crosslinked network polymer with an absorbency capacity of approximately 50 g/g of 0.9% NaCl (aq). Methods for the depolymerization of representative SAPs are provided in U.S. Patent Application Publication No. US20210054161, entitled “Depolymerization of Polymers, published Feb. 25, 2021, which is incorporated herein by reference in its entirety. In some embodiments, the presently disclosed upcycling method includes de-crosslinking, ultrasound-induced depolymerization, and base-catalyzed co-esterification, with an optional deprotection step. The presently disclosed method achieves high molecular weight polyacrylate based PSAs having a molecular weight of about 400 to about 900 kg/mol.

### A. Chemical Modification of Post-Consumer Sodium Poly(Acrylate)

In some embodiments, the presently disclosed subject matter provides a method for converting a sodium polyacrylate to a pressure sensitive adhesive, the method comprising. (a) acid-catalyzed or base-mediated decrosslinking the polyacrylate via hydrolysis to generate a linear polymer; (b) optionally sonicating the linear polymer to lower a molar mass thereof; and (c) functionalizing the linear polymer via esterification to generate a pressure sensitive adhesive.

In some embodiments, the sodium polyacrylate comprises a sodium poly(acrylate) crosslinked via a poly(ethylene glycol) diacrylate co-monomer. In particular embodiments, the one or more sodium polyacrylate-based superabsorbent polymers are derived from a disposable personal hygiene product. In more particular embodiments, the disposable personal hygiene product is selected from the group consisting of a baby diaper, an adult incontinence product, and a feminine hygiene product.

In some embodiments, the base-mediated decrosslinking via hydrolysis step includes contacting the sodium polyacrylate with NaOH under heating for a period of time.

In some embodiments, the acid-catalyzed decrosslinking via hydrolysis step includes contacting the sodium polyacrylate with H₂SO₄ under heating for a period of time.

In some embodiments, the linear polymer is sonicated to a M_{w} of between about 300 kg/mol to about 400 kg/mol, including 300, 310, 320, 330, 340, 350, 360, 370, 380, 390, and 400 kg/mol.

In some embodiments, the method further comprises dialyzing the sonicated linear polymer. In some embodiments, the method further comprises lyophilizing the dialyzed linear polymer. In some embodiments, the method further comprises grinding the lyophilized linear polymer.

In some embodiments, the presently disclosed method further comprises removing the base from the one or more decrosslinked sodium polyacrylate-based superabsorbent polymers. In particular embodiments, the removing of the base from the one or more decrosslinked sodium polyacrylate-based superabsorbent polymers comprises dialyzing the one or more decrosslinked sodium polyacrylate-based superabsorbent polymers using a molecular porous membrane tubing. One of ordinary skill in the art would recognize that other ultrafiltration methods based on size exclusion would be suitable for use with the presently disclosed methods. Non-limiting examples of desalination processes are membrane processes (e.g., reverse osmosis, forward osmosis, electrodialysis reversal (EDR), nanofiltration, and the like), freezing desalination, solar desalination, geothermal desalination, ion exchange, wave powered desalination, and the like.

In some embodiments, the functionalizing of the linear polymer via esterification includes contacting the polyacrylate with an alkyl alcohol in the presence of an acid catalyst. One of ordinary skill in the art would appreciate that the presently disclosed methods could be used with one or more alkyl alcohols. As used herein, the term “alkyl” means, unless otherwise stated, a straight (i.e., unbranched) or branched chain, acyclic or cyclic hydrocarbon group, or combination thereof, which may be fully saturated, mono- or polyunsaturated and can include di- and multivalent groups, having the number of carbon atoms designated (i.e., C₁-C₁₀ means one to ten carbons). In particular embodiments, the term “alkyl” refers to C₁-C₂₀ inclusive, linear (i.e., “straight-chain”), branched, or cyclic, saturated or at least partially and in some cases fully unsaturated (i.e., alkenyl and alkynyl) hydrocarbon radicals derived from a hydrocarbon moiety containing between one and twenty carbon atoms by removal of a single hydrogen atom.

Representative saturated hydrocarbon groups include, but are not limited to, methyl, ethyl, n-propyl, isopropyl, n-butyl, isobutyl, sec-butyl, tert-butyl, n-pentyl, sec-pentyl, iso-pentyl, neopentyl, n-hexyl, sec-hexyl, n-heptyl, n-octyl, n-decyl, n-undecyl, dodecyl, cyclohexyl, (cyclohexyl)methyl, cyclopropylmethyl, and homologs and isomers thereof.

“Branched” refers to an alkyl group in which a lower alkyl group, such as methyl, ethyl or propyl, is attached to a linear alkyl chain. “Lower alkyl” refers to an alkyl group having 1 to about 8 carbon atoms (i.e., a C₁₋₈ alkyl), e.g., 1, 2, 3, 4, 5, 6, 7, or 8 carbon atoms. “Higher alkyl” refers to an alkyl group having about 10 to about 20 carbon atoms, e.g., 10, 11, 12, 13, 14, 15, 16, 17, 18, 19, or 20 carbon atoms. In certain embodiments, “alkyl” refers, in particular, to C₁₋₈ straight-chain alkyls. In other embodiments, “alkyl” refers, in particular, to C₁₋₈ branched-chain alkyls.

Alkyl groups can optionally be substituted (a “substituted alkyl”) with one or more alkyl group substituents, which can be the same or different. The term “alkyl group substituent” includes but is not limited to alkyl, substituted alkyl, halo, arylamino, acyl, hydroxyl, aryloxyl, alkoxyl, alkylthio, arylthio, aralkyloxyl, aralkylthio, carboxyl, alkoxycarbonyl, oxo, and cycloalkyl.

Thus, the presently disclosed methods are applicable to alkyl alcohols, including, but not limited to, methanol, ethanol, n-propanol, isopropanol, n-butanol, isobutanol, sec-butanol, tert-butanol, n-pentanol, sec-pentanol, iso-pentanol, neopentanol, n-hexanol, sec-hexanol, n-heptanol, n-octanol, n-decanol, n-undecanol, dodecanol, each of which can be substituted with one or more substituent groups, including straight-chain or branched alkyl, or halo. The terms “halo,” “halide,” or “halogen” as used herein refer to fluoro, chloro, bromo, and iodo groups.

In some embodiments, the alkyl alcohol is 2-ethylhexanol.

In some embodiments, the acid comprises an inorganic acid. In other embodiments, the acid comprises an organic acid. Representative inorganic acids include, but are not limited to, hydrochloric acid, nitric acid, phosphoric acid, sulfuric acid, boric acid, hydrofluoric acid, hydrobromic acid, perchloric acid, and hydroiodic acid. In particular embodiments, the inorganic acid is sulfuric acid. Representative organic acids include, but are not limited to, arylsulfonic acids, such as benzenesulfonic acid, tosylic acid, p-styrenesulfone, 2-naphthalenesulfonic acid, 4-hydroxybenzenesulfonic acid, 5-sulfosalicylic acid, p-dodecylbenzenesulfonic acid, dihexylbenzenesulfonic acid, 2,5-dihexylbenzenesulfonic acid, dibutylnaphthalenesulfonic acid, 6,7-dibutyl-2-naphthalenesulfonic acid, dodecylnaphthalenesulfonic acid, 3-dodecyl-2-naphthalenesulfonic acid, hexylnaphthalenesulfonic acid, 4-hexyl-1-naphthalenesulfonic acid, octylnaphthalenesulfonic acid, 2-octyl-1-naphthalenesulfonic acid, hexylnaphthalenesulfonic acid, 7-hexyl-1-naphthalenesulfonic acid, 6-hexyl-2-naphthalenesulfonic acid, dinonylnaphthalenesulfonic acid, 2,7-dinonyl-4-naphthalenesulfonic acid, dinonylnaphthalenedisulfonic acid, 2,7-dinonyl-4,5-naphthalenedisulfonic acid, and the like.

In certain embodiments, the acid is sulfuric acid.

### B. One-Poi Synthesis of Pressure-Sensitive Adhesives Combining Protonation

In some embodiments, the presently disclosed subject matter provides a mild and efficient one-pot synthetic route for open-loop recycling the acrylic-based superabsorbent material used, for example, in diapers.

As provided hereinabove, the SAP described herein is an insoluble, crosslinked network polymer with an absorbency capacity of approximately 50 g/g of 0.9% NaCl (aq). Methods for the depolymerization of representative SAPs are provided in U.S. Patent Application Publication No US20210054161, entitled “Depolymerization of Polymers, published Feb. 25, 2021, which is incorporated herein by reference in its entirety. In some embodiments, the presently disclosed upcycling method includes de-crosslinking, ultrasound-induced depolymerization, and base-catalyzed co-esterification, with an optional deprotection step. The presently disclosed method achieves high molecular weight polyacrylate based PSAs having a molecular weight of about 400 to about 900 kg/mol.

Accordingly, in some embodiments, the presently disclosed subject matter utilizes PAA_{P&G} open-loop recycling to make pressure sensitive adhesives (PSAs) in one pot. The presently disclosed one-pot synthesis arises from condensing multiple, otherwise separate, reactions steps into one operation without isolating intermediates. See Hayashi, 2016.

Conducting a one-pot synthesis in this manner can result in economic and environmental benefits. Without wishing to be bound to any one particular theory, it was thought that because acid hydrolysis and acid-catalyzed esterification are similar reactions, a one-pot method for decrosslinking and functionalizing PAA_{P&G} to make PSAs would be feasible.

Accordingly, in some embodiments, the presently disclosed subject matter provides a one-pot synthesis method for converting a sodium polyacrylate to a pressure sensitive adhesive, the method comprising: (a) disposing an alkyl alcohol and a sodium polyacrylate into a reaction vessel to form a first reaction mixture; (b) adding a protic solvent and an acid to the reaction vessel to form a second reaction mixture; (c) heating the second reaction mixture with stirring to form a polymer comprising a pressure sensitive adhesive.

In some embodiments, the method further comprises bubbling an inert gas through the first reaction mixture and/or the second reaction mixture for a period of time to remove oxygen from the reaction vessel. In particular embodiments, the inert gas comprises nitrogen.

One of ordinary skill in the art would appreciate that the presently disclosed methods could be used with one or more alkyl alcohols. As used herein, the term “alkyl” means, unless otherwise stated, a straight (i.e., unbranched) or branched chain, acyclic or cyclic hydrocarbon group, or combination thereof, which may be fully saturated, mono- or polyunsaturated and can include di- and multivalent groups, having the number of carbon atoms designated (i.e., C₁-C₁₀ means one to ten carbons). In particular embodiments, the term “alkyl” refers to C₁-C₂₀ inclusive, linear (i.e., “straight-chain”), branched, or cyclic, saturated or at least partially and in some cases fully unsaturated (i.e., alkenyl and alkynyl) hydrocarbon radicals derived from a hydrocarbon moiety containing between one and twenty carbon atoms by removal of a single hydrogen atom.

Representative saturated hydrocarbon groups include, but are not limited to, methyl, ethyl, n-propyl, isopropyl, n-butyl, isobutyl, sec-butyl, tert-butyl, n-pentyl, sec-pentyl, iso-pentyl, neopentyl, n-hexyl, sec-hexyl, n-heptyl, n-octyl, n-decyl, n-undecyl, dodecyl, cyclohexyl, (cyclohexyl)methyl, cyclopropylmethyl, and homologs and isomers thereof.

“Branched” refers to an alkyl group in which a lower alkyl group, such as methyl, ethyl or propyl, is attached to a linear alkyl chain. “Lower alkyl” refers to an alkyl group having 1 to about 8 carbon atoms (i.e., a C₁₋₈ alkyl), e.g., 1, 2, 3, 4, 5, 6, 7, or 8 carbon atoms. “Higher alkyl” refers to an alkyl group having about 10 to about 20 carbon atoms, e.g., 10, 11, 12, 13, 14, 15, 16, 17, 18, 19, or 20 carbon atoms. In certain embodiments, “alkyl” refers, in particular, to C₁₋₈ straight-chain alkyls. In other embodiments, “alkyl” refers, in particular, to C₁₋₈ branched-chain alkyls.

Alkyl groups can optionally be substituted (a “substituted alkyl”) with one or more alkyl group substituents, which can be the same or different. The term “alkyl group substituent” includes but is not limited to alkyl, substituted alkyl, halo, arylamino, acyl, hydroxyl, aryloxyl, alkoxyl, alkylthio, arylthio, aralkyloxyl, aralkylthio, carboxyl, alkoxycarbonyl, oxo, and cycloalkyl.

Thus, the presently disclosed methods are applicable to alkyl alcohols, including, but not limited to, methanol, ethanol, n-propanol, isopropanol, n-butanol, isobutanol, sec-butanol, tert-butanol, n-pentanol, sec-pentanol, iso-pentanol, neopentanol, n-hexanol, sec-hexanol, n-heptanol, n-octanol, n-decanol, n-undecanol, dodecanol, each of which can be substituted with one or more substituent groups, including straight-chain or branched alkyl, or halo. The terms “halo,” “halide,” or “halogen” as used herein refer to fluoro, chloro, bromo, and iodo groups.

In certain embodiments, the alkyl alcohol is 2-ethylhexanol or butyl alcohol.

In some embodiments, the acid comprises an inorganic acid. In other embodiments, the acid comprises an organic acid. Representative inorganic acids include, but are not limited to, hydrochloric acid, nitric acid, phosphoric acid, sulfuric acid, boric acid, hydrofluoric acid, hydrobromic acid, perchloric acid, and hydroiodic acid. In particular embodiments, the inorganic acid is sulfuric acid. Representative organic acids include, but are not limited to, arylsulfonic acids, such as benzenesulfonic acid, tosylic acid, p-styrenesulfone, 2-naphthalenesulfonic acid, 4-hydroxybenzenesulfonic acid, 5-sulfosalicylic acid, p-dodecylbenzenesulfonic acid, dihexylbenzenesulfonic acid, 2,5-dihexylbenzenesulfonic acid, dibutylnaphthalenesulfonic acid, 6,7-dibutyl-2-naphthalenesulfonic acid, dodecylnaphthalenesulfonic acid, 3-dodecyl-2-naphthalenesulfonic acid, hexylnaphthalenesulfonic acid, 4-hexyl-1-naphthalenesulfonic acid, octylnaphthalenesulfonic acid, 2-octyl-1-naphthalenesulfonic acid, hexylnaphthalenesulfonic acid, 7-hexyl-1-naphthalenesulfonic acid, 6-hexyl-2-naphthalenesulfonic acid, dinonylnaphthalenesulfonic acid, 2,7-dinonyl-4-naphthalenesulfonic acid, dinonylnaphthalenedisulfonic acid, 2,7-dinonyl-4,5-naphthalenedisulfonic acid, and the like. In certain embodiments, the acid is sulfuric acid.

In certain embodiments, the protic solvent is water or a hydrophilic alcohol. Protic solvents include, but are not limited to, formic acid, n-butanol, isopropanol, ethanol, methanol, acetic acid, and water. Hydrophilic alcohols include, but are not limited to methanol, ethanol, n-propyl alcohol, isopropyl alcohol, and t-butyl alcohol. In particular embodiments, the hydrophilic alcohol is methanol or ethanol.

In some embodiments, the method further comprises cooling the reaction vessel. In some embodiments, the method further comprises isolating the polymer comprising the pressure sensitive adhesive by precipitating into an alcohol. In some embodiments, the method further comprises centrifugation of the precipitate.

In some embodiments, the method further comprises removing one or more byproducts. In some embodiments, the method further comprises purifying by dissolving/swelling the polymer comprising the pressure sensitive adhesive in tetrahydrofuran (THF) and precipitating with methanol and drying under vacuum.

In some embodiments, the sodium polyacrylate comprises a sodium poly(acrylate) crosslinked via a poly(ethylene glycol) diacrylate co-monomer. In particular embodiments, the one or more sodium polyacrylate-based superabsorbent polymers are derived from a disposable personal hygiene product. In more particular embodiments, the disposable personal hygiene product is selected from the group consisting of a baby diaper, an adult incontinence product, and a feminine hygiene product.

### C. Articles Comprising a Pressure Sensitive Adhesive

In some embodiments, the presently disclosed subject matter provides an article comprising pressure sensitive adhesive formed by the presently disclosed methods. In some embodiments, the article is selected from the group consisting of pressure sensitive tape, a bandage, a label, note pads, a decal, a stamp, an envelope, a sticker, packaging, automobile trim, and a film.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount, or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter. The synthetic descriptions and specific examples that follow are only intended for the purposes of illustration, and are not to be construed as limiting in any manner to make compounds of the disclosure by other methods.

### Example 1

### Chemical Modification of Post-Consumer Sodium Poly(Acrylate)

### 1.1 Background

There is an estimated 6.3 billion metric tons of post-consumer polymer waste, with the vast majority (79%) in landfills or leaked into the environment. Recycling methods that utilize this existing resource (waste polymers) could attenuate their environmental impact. For many polymers, however, recycling via mechanical processes is not feasible, and as a consequence, these materials are destined for landfills or incineration.

One salient example is the superabsorbent material used in diapers and feminine hygiene products, which are made from crosslinked sodium polyacrylates. The presently disclosed subject matter provides an open-loop recycling method for these materials that involves (i) decrosslinking via hydrolysis, (ii) an optional chain-shortening step via sonication, and (iii) functionalizing via Fischer esterification. The resulting materials exhibit low-to-medium storage and loss moduli, and as such, are applicable as general-purpose adhesives for products including tapes, bandages, and sticky notes. A life cycle analysis demonstrated that the adhesives synthesized via this approach outcompetes the same materials derived from petroleum feedstocks on nearly every metric, including carbon dioxide emissions and cumulative energy demand. This potentially scalable route to recycling diapers and feminine hygiene products could keep 2 million metric tons of polymer waste from landfills each year.

For decades, mechanical recycling has been used to recover some value from waste polymers, although recycling rates are low, Advancing Sustainable Materials Management: 2017 Fact Sheet. (EPA 530-F-19-001), and the material quality is often reduced. Moreover, mechanical recycling cannot be used with polymers that do not reversibly melt (e.g., crosslinked polymers). An alternative recycling route known as chemical recycling was developed to address these challenges. Hong and Chen, 2017; Rahimi and Garcia, 2017; Thiounn and Smith, 2020; Coates and Getzler, 2020. In closed-loop chemical recycling, chemical transformations are used to cleave the polymer into its monomers (depolymerization), or to create a polymer with equivalent function. Ellen MacArthur Foundation. When closed-loop processes are unavailable, an alternative, known as open-loop chemical recycling can be utilized. Here, chemical transformations are used to convert waste polymers into other value-added materials, delaying their entry into the waste stream.

### 1.2 Scope

In some embodiments, the presently disclosed subject matter provides a new method to open-loop recycle the superabsorbent materials used in disposable diapers and feminine hygiene products. The global annual production of this superabsorbent material is estimated to be over 2 million metric tons, with disposable diapers claiming 74% of the market. Future Market Insights. Unfortunately, most used diapers sit in landfills for centuries without substantial biodegradation, or are incinerated. To date, most diaper recycling efforts, Khoo et al., 2019, have focused on the cellulosic components, which can be biodegraded, incinerated to generate steam, pyrolyzed, or fermented to generate bioethanol. Liang et al., 2018. In contrast, few studies have examined recycling of the sodium polyacrylate superabsorbent polymers. Mechanical recycling is not feasible because the crosslinks prevent melting. Decrosslinking has been reported using ozonolysis, Ichiura et al., 2020, though not for the purposes of mechanical recycling.

Closed-loop chemical recycling via depolymerization to monomer also is not currently feasible for these superabsorbent materials because side-chain degradation outcompetes depolymerization. For example, upon heating, polyacrylic acid is known to undergo dehydration and decarboxylation in bulk, McNeil and Sadeghi, 1990, and solution, Lepíne and Gilbert, 2002, respectively. Recent efforts to sidestep this degradation using microwaves and added radicals led to oligomeric products with 50-60/o decarboxylation. Ching et al., 2020. While catalytic depolymerization methods, Tang et al., 2018, can, in principle, proceed without side-chain degradation, they have not yet been demonstrated for commercial sources of polyacrylic acid. Due to these challenges, the focus has been on re-use of recovered materials, rather than recycling; for example, the recovered superabsorbent polymers have been explored for enhancing the water retention properties of soil. Zekry et al., 2020; Al-Jabari et al., 2019.

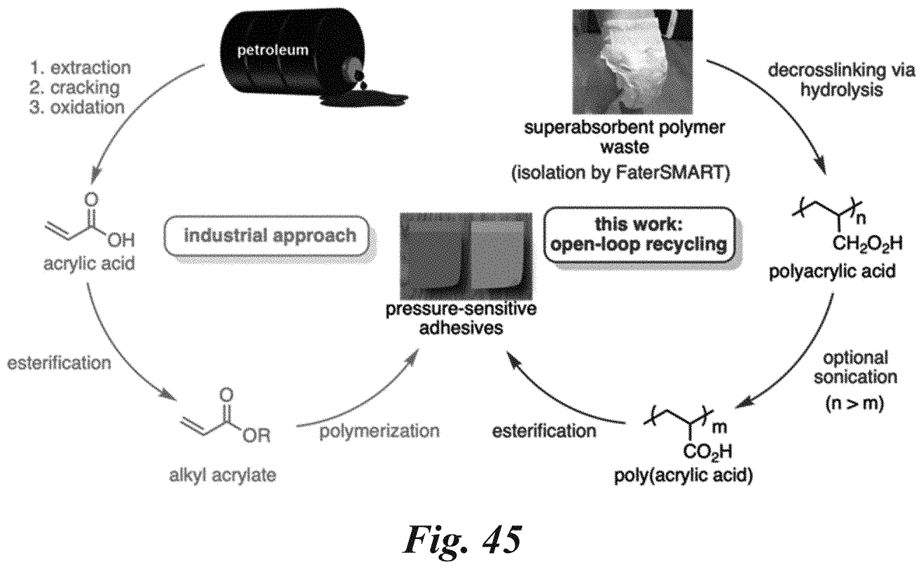

The presently disclosed subject matter provides a mild and efficient synthetic route for open-loop recycling the acrylic-based superabsorbent material used in diapers. Specifically, using a two- or three-step synthetic process, the sodium polyacrylate is converted into a pressure-sensitive adhesive (PSA), which has a significant global market (expected to be $13 billion by 2023). Allied Market Research.com. This approach was inspired by the similar structures of sodium polyacrylate (superabsorbent polymer) and the polyacrylates (pressure-sensitive adhesives) used in tapes, bandages, and sticky notes, among others. Creton, 2003. Commercial polyacrylate-based PSAs are often accessed via petroleum-sourced monomers (FIG. 45). U.S. Pat. No. 9,822,286, for Self-Wetting Adhesive Composition, to Fornof et al., issued Nov. 21, 2017; Pocious, 2012; Lehmann, 2015.

In contrast to this route, the presently disclosed subject matter provides a two- or three-step method from crosslinked sodium polyacrylate. (i) acid-catalyzed or base-mediated decrosslinking to generate linear polymers, (ii) optional sonication to lower the molar mass, and (iii) functionalizing via esterification to generate tack (FIG. 45).

In any recycling effort, it is essential that a life cycle assessment, Bjorn et al., 2018, is performed to determine the energy and environmental costs. The presently disclosed subject matter demonstrates that an open-loop recycling approach to pressure-sensitive adhesives from superabsorbent polymers outcompetes the petroleum-derived syntheses on nearly every metric, including carbon dioxide emissions and cumulative energy demand.

Moreover, the route involving just decrosslinking and esterification (i.e., no sonication) has the potential to be industrially scalable, providing a sustainable solution to a longstanding waste problem.

1.2.1 Isolation from Post-Consumer Waste.

Globally, there have been significant efforts towards recycling the components of diapers. Takaya et al., 2019. For example, FaterSMART, a P&G affiliated company, has developed and implemented a diaper recycling facility that includes used diaper acquisition, steam sterilization, shredding, and separation into the purified raw materials (cellulosics, superabsorbent polymer, and polyolefins). FaterSMART.com. These important steps have been included in the life cycle assessments, however, the presently disclosed syntheses utilized the more readily accessible samples of superabsorbent polymer used to manufacture diapers at P&G.

### 1.2.2 Decrosslinking Via Hydrolysis.

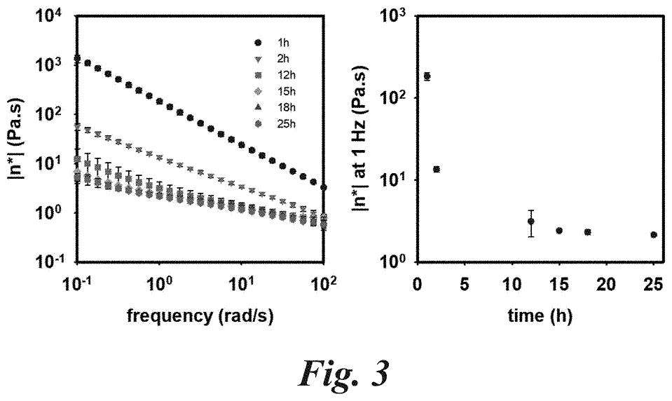

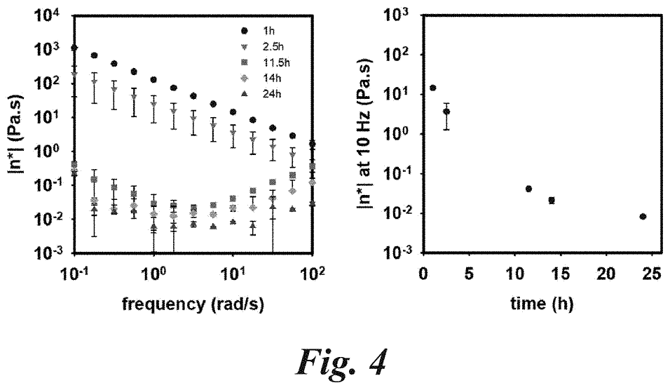

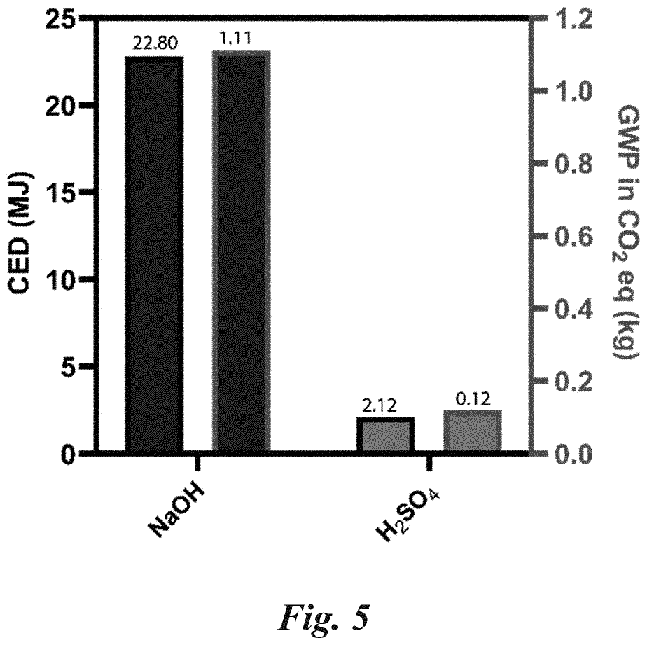

The superabsorbent polymer provided by P&G is a sodium poly(acrylate) crosslinked via a poly(ethylene glycol) diacrylate co-monomer (PAA_{P&G}). The crosslinks were first hydrolyzed using 0.3 M aq. NaOH and mild heating (Scheme 2). The initially heterogeneous reaction mixture becomes a homogeneous solution over time due to the chemical change from a superabsorbent gel-like substance into the soluble, linear polymer products. By measuring changes in the complex viscosity over time, no further changes were observed after 15 h, suggesting that the majority of crosslinks had been hydrolyzed (FIG. 3). For comparison, hydrolysis using 0.8 M aq. H₂SO₄ with heating also was evaluated (Scheme 2). The complex viscosity reached a plateau around 24 h, suggesting most crosslinks were hydrolyzed at this point (FIG. 4). To determine whether the base-mediated or acid-catalyzed pathway was better, the two routes were compared using a life cycle assessment (LCA, FIG. 5). The acid-catalyzed hydrolysis outperformed the base-mediated hydrolysis by a factor of approximately 10 on both global warming potential and cumulative energy demand. The resulting acidic polymer solutions were used directly in the subsequent sonication experiments without any isolation steps.

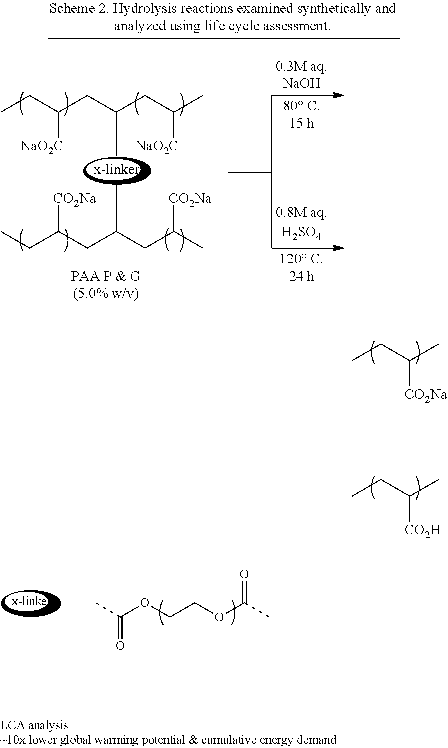

### 1.2.3 Chain-Shortening Via Sonication.

To access more than one type of pressure-sensitive adhesive, we needed a method to shorten the linear polymers obtained after the decrosslinking step. Sonication has previously been used to chain-shorten high-molar mass polymers with various backbone architectures, Caruso et al., 2009; Li et al., 2015, including polyacrylic acid. Prajapat and Gogate, 2016. Under ultrasound, solvodynamic shear forces cleave polymer chains into shorter fragments while maintaining the polymer's chemical identity. The rate of chain scission during sonication is directly proportional to the amount of chain entanglement during sonication. Chubarova et al., 2013. As a consequence, there is an intrinsic, limiting molar mass for each polymer below which further chain scissions are unlikely to occur. Experimentally, a plateau is observed in the plot of weight-average molar mass (M_{w}) versus sonication time.

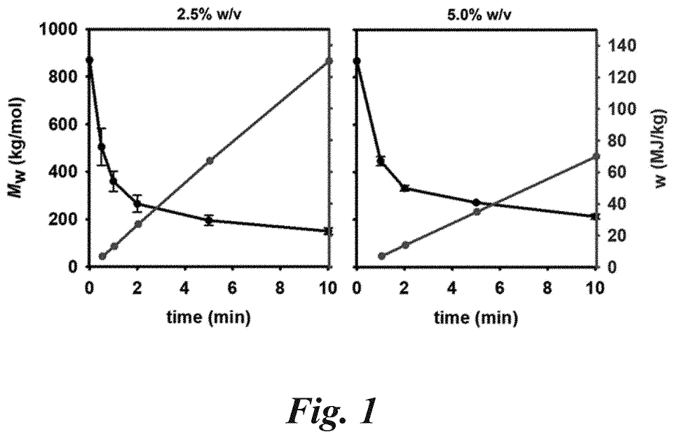

Sonicating 2.5% and 5.0% w/v solutions of decrosslinked PAA_{P&G} for 0-10 min using a 20 kHz sonication horn operating at full amplitude (100%) revealed rapid chain-shortening for the decrosslinked PAA_{P&G} (FIG. 1). At each time point, the maximum specific energy (wₘₐₓ) was calculated using the maximum power drawn from the outlet and the mass of added PAA. The M_{w} was determined relative to polyethylene glycol/polyethylene oxide standards using SEC.

To achieve the necessary cohesive and holding strength for a PSA, the polymer (after esterification) should have a M_{w}>400 kg/mol. Tobing and Klein, 2001. Considering this factor, the optimized conditions involved sonicating a 2.5% w/v solution for 1 min to give an M_{w} approximately 360 kg/mol, and a 5.0% w/v solution for 2 min to give a M_{w} of approximately 330 kg/mol. Collias et al., 2021. The resulting chain-shortened PAA_{P&G} fragments were then dialyzed to remove excess acid, lyophilized, and then ground into a powder. A life cycle assessment was used to compare the routes that involved (i) no sonication, (ii) sonication for 1 min (2.5% w/v) and (iii) sonication for 2 min (5.0% w/v), including the workup steps, and will be described in more detail below.

### 1.2.4 Esterification of Polymer Fragments.

Several routes for converting the polyacrylic acid into a polyacrylate were compared. Esterification of polyacrylic acid using alkyl halides under basic conditions had already been reported. Li et al., 2013. This process, however, utilizes expensive solvents (dimethylsulfoxide or dimethylformamide) and stoichiometric quantities of base (tetramethylguanidine), both of which would likely be too costly for large-scale recycling of waste superabsorbent materials. In contrast, a common approach used in industry to convert acrylic acid monomers into acrylate monomers uses inexpensive alcohols as both the reagent and solvent. Bauer et al., 2003; Ohara et al., 2012. This approach, however, can lead to low yields due to competitive ester hydrolysis, Roberts and Urey, 1939; Raber et al., 1979, and catalyst deactivation with water. Liu et al., 2006. To circumvent these challenges, the water by-product can be selectively removed via azeotropic distillation, or a large excess of alcohol can be employed. U.S. Pat. No. 2,917,538 for Process for the Production of Acrylic Acid Esters, to Carlyle, issued Dec. 15, 1959; U.S. Pat. No. 9,321,863 for Synthesis of Acrylic or Methacrylic Acid/Acrylate or Methacrylate Ester Polymers Using Pervaporation, to Alarifi et al., issued Apr. 26, 2016.

Without wishing to be bound to any one particular theory, it is thought that we could potentially eliminate the need to remove water because both the polymer backbone and our alcohol solvent are hydrophobic. See McNeil et al., Esterifying Polyacrylic Acid with High Conversion. U.S. Patent Application 62/947,363, Dec. 12, 2019; see also International PCT Patent Application Publication No. WO2021041326 for Super Absorbent Polymer Recycling to Pressure Sensitive Adhesives, to Collias et al., published Mar. 4, 2021, each of which is incorporated herein by reference in its entirety.

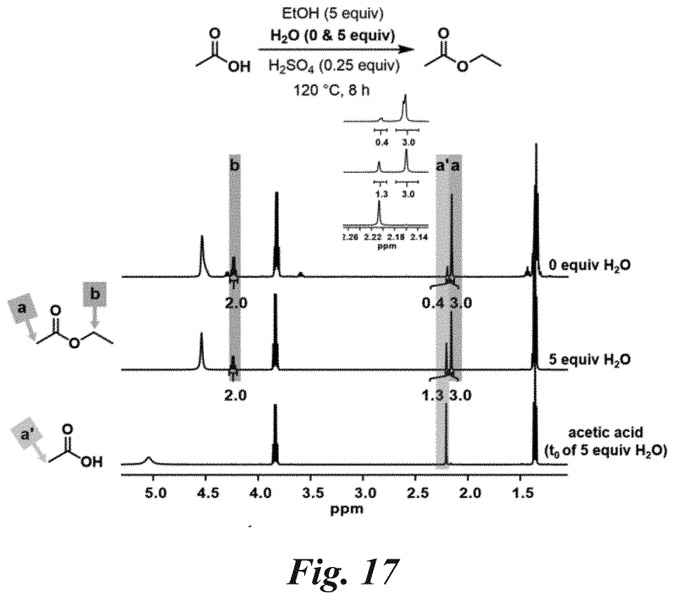

To interrogate this hypothesis, we measured the percent esterification under different conditions. For example, high degrees of esterification were observed via ¹H NMR and IR spectroscopy when using only 3 equiv. of 2-ethylhexanol and H₂SO₄ as a catalyst (Scheme 3). Surprisingly, even when excess H₂O was intentionally added (3 equiv), the esterification was still quantitative (see FIG. 17). The results from both of these experiments demonstrate that the equilibrium lies far towards the esterification product.

To understand why esterification is so favored, we turned to small molecule model systems. To probe the role of both solvent and substrate hydrophobicity, we used two different substrates (acetic versus undecanoic acid) and solvents (ethanol versus 2-ethylhexanol). When acetic acid was reacted with 2-ethylhexanol/water, we observed approximately a 92% conversion. In contrast, when acetic acid was reacted with ethanol/water, the conversion was only 67%. These results demonstrate that solvent hydrophobicity improves conversion to the ester. Next, undecanoic acid was esterified under the same conditions, yielding 100% ester for 2-ethylhexanol/water and 85% for ethanol/water. These results suggest that the substrate hydrophobicity also favors conversion to the ester. From these studies, we conclude that the quantitative esterification of the polymer results from the hydrophobic reaction environment created by the polymer backbone and the 2-ethylhexanol solvent.

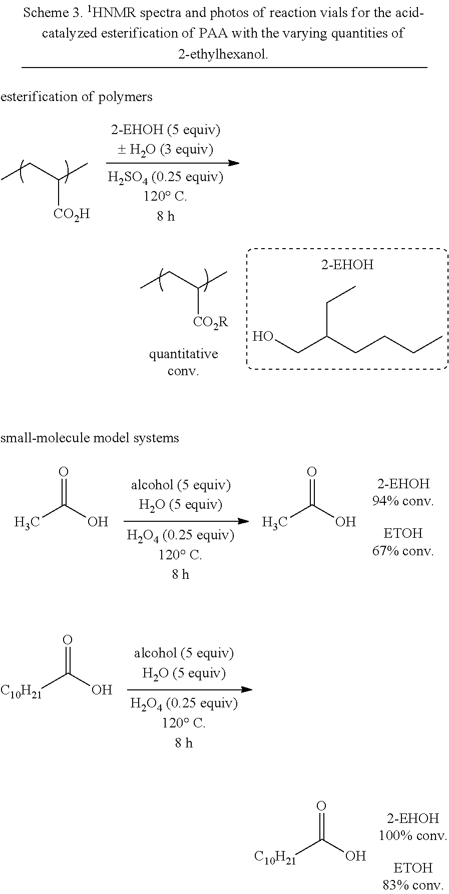

To probe whether the hydrophobic side chains also push the equilibrium towards esterification, atomistic simulations were used (Scheme 4). Vilseck et al., 2019; Hayes et al., 2017. Briefly, nonamers of polyacrylic acid were used as a model system along with butyl alcohol. Comparison of the reaction free energies was made between the first esterification and the final esterification. In both cases, the nonamers were solvated in a 3:1 butanol/water mixture to mimic the most challenging esterification conditions. The change in the Helmholtz free energy of esterification for these two steps (ΔΔA) was found to be −0.7±0.1 kcal/mol, suggesting that the increase in polymer hydrophobicity due to partial esterification provides a small additional thermodynamic driving force towards further esterification.

### 1.2.5 Characterizing the Adhesive Properties.

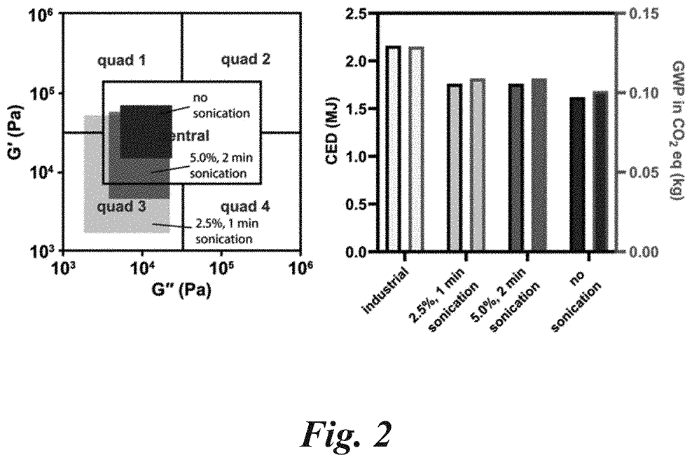

The adhesive properties of the synthesized polyacrylates were evaluated using rheology and analyzed with respect to Chang's viscoelastic window (VW), which classifies different adhesive types. Chang, 1991. In this approach, the VW for each PSA is constructed from the dynamic storage (G′) and loss (G″) moduli at representative bonding and debonding frequencies of 0.01 and 100 Hz, respectively. The corresponding VW for each adhesive is the rectangular region bounded by these four moduli (FIG. 2). Chang noted that most existing PSAs appear between the G′ and G″ bounds of 10³ and 10⁶ Pascals (Pa) at the aforementioned bounding frequencies, and can be grouped into the quadrants (and central region) highlighted in FIG. 2. The G′ at each frequency describes an adhesive's resistance to shear, and this term generally increases in samples with more chain entanglements (e.g., with increasing M_{w}). The G″ at each frequency describes an adhesive's ability to dissipate energy. Most consumer PSA-based products are found in either quad 3 or the central region (e.g., office tape, sticky notes, bandages, and removable labels), which is signified by low-to-medium G′ and G″.

All the adhesives synthesized from PAA_{P&G} fall within quad 3 and the central region (FIG. 2). That is, the PSAs are soft enough to flow and wet a substrate at the bonding frequency, while hard enough to hold onto a substrate, and peel cleanly at the debonding frequency. As expected, the VWs are higher with larger M_{w}, which is due to the increased chain entanglements. Overall, the viscoelastic properties of the synthesized PSAs suggest they would be useful for applications such as removable general-purpose adhesives, including tapes, bandages, and sticky notes.

### 1.2.6 Life Cycle Analyses.

Life cycle assessments (LCA) were performed to assess the cumulative energetic and environmental impacts of producing 5,000 mg of adhesive via our repurposing method compared to the current industrial synthesis. More specifically, we compared four different LCA scenarios: poly (2-ethylhexylacrylate) production as outlined in the industrial approach (Scheme 1) and three variations of the process: (i) sonicating the 2.5% w/v polymer solution for 1 min (2.5%_1 min), (ii) sonication the 5.0% w/v polymer solution for 2 min (5%_2 min), and (iii) no sonication of the 5% w/v polymer solution (5%_0 min). All environmental data were gathered from the experiments, literature, and the ecoinvent database (version 3.5), Wernet et al., 2016, and implemented in SimaPro v. 9.0.0.48, Wernet et al., 2016, as described in detail herein below. Several environmental impact categories were examined, but particular attention was paid to the global warming potential (GWP, measured by CO₂ equiv) and cumulative energy demand (CED). We found a 13.2% and 12.4% decrease in GWP when switching from the petroleum route to either the 1 min or 2 min sonication scenario, respectively. Most notably, there is a 19.4% decrease in GWP between the petroleum route and the open-loop recycling method with no sonication. For CED, there is a 18.6% and 18.4% decrease when switching from the petroleum route to the sonication scenarios respectively. Again, the repurposing route that does not involve sonication shows an even larger improvement, with a 24.6% reduction in CED. Combined, these data indicate that reusing superabsorbent poly(acrylic acid) to synthesize PSAs is both energetically and environmentally more favorable than petroleum, with a few key assumptions.

Given a growing emphasis on sustainability within the polymer industry, including calls to increase the circularity of polymer production, this LCA provides an important metric for evaluating new approaches to polymer recycling. At present, the environmental benefits of diaper recycling (including superabsorbent poly(acrylic acid) recovery) are dependent on the avoided material burdens. Arena et al., 2016. One of the pitfalls of diaper recycling pilots is the low demand for recovered diaper materials, which depreciates the environmental potentiality of such endeavors. Khoo et al., 2019. Therefore, efforts to introduce synergy between superabsorbent poly(acrylic acid) recovery and PSA production may provide much-needed demand for diaper recycling end-products, which in-turn may improve environmental performance for both processes on a large scale.

In summary, the presently disclosed subject matter provides a facile and potentially scalable method to synthesize commercially relevant PSAs by open-loop recycling poly(acrylic acid) sourced from a leading diaper manufacturer. The transformation relies on an (i) acid-catalyzed hydrolysis, (ii) optional chain-shortening via sonication, and (iii) a highly efficient esterification drive by hydrophobicity. Different PSAs were targeted simply by varying the sonication times from 0-2 min. Because this process can use waste polymer as the feedstock, it provides a more sustainable alternative to disposal in a landfill or incineration. Moreover, the life cycle assessment demonstrated that these repurposing routes outperform existing industrial syntheses from petroleum-derived starting materials on nearly metric, including impressive reductions in the global warming potential and cumulative energy demand. Overall, this sustainable approach to a challenging recycling problem, and its potential for scalability, should benefit the polymer industry.

### 1.3 Materials

All chemicals were used as received unless otherwise mentioned. Polyacrylic acid (PAA) with molecular weight listed as 750 kg/mol (PAA_{SPP}) was purchased from Scientific Polymer Products. PAA_{SIGMA1} (listed as 240 kg/mol), PAA_{SIGMA2} (listed as 450 kg/mol), Dowex® Marathon™ MSC hydrogen form (23-27 μm), p-toluenesulfonic acid (p-TsOH), 2-ethylhexanol (2-EHOH), dimethyl sulfoxide (DMSO), sodium hydroxide, sulfuric acid, and sodium nitrate were purchased from Millipore Sigma. Methanol (MeOH) and sodium chloride (NaCl) were purchased from Fisher Scientific. Tetrahydrofuran (THF) was purchased from OmniSolv. Glacial acetic acid was purchased from Acros Organics. Deuterated solvents: chloroform (CDCl₃), pyridine-d₅, and deuterium oxide (D₂O) were purchased from Cambridge Isotopes. Sodium polyacrylate (PAA_{P&G}) was provided by Procter & Gamble. PAA_{SIGMA1} and PAA_{SIGMA2} were used for esterification experiments without chain-shortening. PAA_{SPP} and PAA_{P&G} were chain-shortened to shorter fragments before esterification. Sonicated polymer fragments were dialyzed in deionized (DI) water using Spectra/Por molecular porous membrane tubing (molecular weight cut-off: 3.5 kg/mol). Pressure tube vessels were purchased from Thomas Scientific. Jacketed beakers were purchased from Sigma Aldrich (cat #: Z202738-1EA).

### 1.5 General Experimental

### 1.5.1 Sonication—

Sonication was performed at 100% amplitude (amp) using a Sonics and Materials Vibra-cell VCX 600 Ultrasonic Liquid Processor equipped with a 13-mm replaceable tip probe. A 3.5 cm inner diameter, 9 cm height jacketed beaker was used for all sonication procedures. Cold water (10-15° C.) was flowed through the jacket while stirring the polymer solution at 500 rpm. A thermocouple was immersed into the polymer solution to monitor temperature. The temperature was generally observed to increase from 10-15° C. to 45-50° C. during sonication. The power from the outlet was monitored using a kill-a-watt meter (#P4400). The maximum power (Pₘₐₓ) reading observed at the beginning of sonication was recorded. The maximum specific energy (wₘₐₓ) for chain-shortening PAA of mass (m) for time (t) was determined using equation (1).

$${w}_{max} ( J / kg ) = \frac{{P}_{max} ( W ) \times t ( s )}{m ( kg )} \qquad ( 1 )$$

### 1.5.2 NMR Spectroscopy—

Unless otherwise noted, ¹H and ¹³C NMR spectra for all compounds were acquired at room temperature. Chemical shift data are reported in units of δ (ppm) relative to tetramethylsilane (TMS) and referenced with residual solvent. Multiplicities are reported as follows: singlet (s), doublet (d), doublet of doublets (dd), triplet (t), quartet (q), multiplet (m), and broad resonance (br). Residual water is denoted by an asterisk (*). For all ¹H NMR spectra of polymers, a 2.5 s acquisition time was used with a 10 s relaxation delay in between each pulse.

1.5.3 Size Exclusion Chromatography (SEC) for PAA_{SPP} and PAA_{P&G} Fragments—

Sonicated PAA_{SPP} and PAA_{P&G} fragments were diluted (to 1-1.5 mg/mL) with 0.1 M NaNO₃ (aq)/ethylene glycol (99:1 v/v) and filtered through a Titan3™ Nylon syringe filter (0.45 μm) into a SEC vial.

Polymer molecular weight (M) and dispersity (D) were determined by comparison with PEG/PEO EasiVial standards from Agilent at 40° C. in 0.1 M NaNO₃ (aq) on a Waters SEC (Waters 1515 Isocratic HPLC pump, 717plus autosampler, RI detector Model 214 and UV-PDA detector Model 487) equipped with four Ultrahydrogel columns: 120 (WAT011565), 250 (WAT011525), 500 (WAT011530) and 1000 (WAT011535).

### 1.5.4 SEC for Polyacrylate Based PSAs (Pressure-Sensitive Adhesives)—

The synthesized PSAs were dissolved (1-2 mg/mL) in THF with mild heating and filtered through a PTFE filter (0.45 μm) into an SEC vial.

Polymer molecular weight (M) and dispersity (Ð) were determined by comparison with poly(methyl methacrylate) ReadyCal-Kit standards from Perfect Separation Solutions at 40° C. in THF on an SEC (Waters APC PUMP and Sample manager, Waters APC RI detector serial #H15URI545M and Wyatt uDAWN 1067UD 3-Angle light scattering detector) equipped with a Shodex HFIP-G 8B Guard Column, 2-Shodex HFIP-806M Columns (serial numbers E28T0045, E2960061, and E2910020, 7.8×300 mm in series).

### 1.5.5 Rheology—

All rheological measurements were taken on an AR2000ex rheometer (TA Instruments).

A 40-mm stainless steel parallel plate was used to run frequency sweeps for decrosslinked PAA_{P&G}. An aliquot of the PAA solution/gel (1.2 mL) was added onto the bottom plate of the rheometer. The upper plate/geometry (40 mm stainless steel) was initially brought down to a gap of 605 μm. While the geometry rotation was locked, excess sample was wiped off (using a custom built glass piece) by trimming excess sample along the circumference of the geometry. Thereafter, the plate was lowered to the desired gap of 600 μm. There is a TA instruments video on YouTube that details this procedure (youtube.com/watch?v=kFiVLSzjUlc). Approximately DI water (1.2 mL) was added into the solvent cavity on the plate flowed by covering with a solvent trap. There is a TA instruments video on YouTube that details this procedure (youtube.com/watch?v=OQmAtdvYrws). The frequency sweeps were performed between 0.1 and 100 Hz at 1% strain and 25° C. This process was repeated at least twice for each sample with cleaning and calibration between runs.

A 25-mm serrated parallel plate was used to run frequency sweeps for PSAs. PSA (approximately 600 mg) was loaded to achieve a 1,250 μm layer thickness. The frequency sweeps were performed between 0.01 and 100 Hz at 1% strain and 25° C. This process was repeated at least twice for each sample with cleaning and calibration between runs.

### 1.6 Comparing Base-Mediated Versus Acid-Catalyzed Decrosslinking of PAA_{P&G}

### SAPdepol157.

Monitoring decrosslinking at 0.3 M NaOH. A 0.3 M aq. NaOH stock solution was prepared by adding NaOH (600 mg, 15 mmol) to a 50 mL volumetric flask followed filling the flask to the mark with DI H₂O (50 mL). PAA_{P&G} (250 mg) was added to separate 20 mL vials equipped with stir bars followed by aq. NaOH (0.3 M, 5.0 mL). The vials were stirred at 350 rpm on a hot plate at 80° C. for the appropriate time (i.e., 1, 2, 12, 15, 18, and 25 h). Each vial was quenched by cooling in a water bath at 25° C. followed by adding acetic acid (90 uL, 1.5 mmol) to quench the NaOH. A pH of 6-7 was observed using pH paper.

The polymer solutions/gel were characterized using a 40-mm stainless steel parallel plate rheometer.

1.7 Monitoring Decrosslinking Over Time Using 0.3 M aq. H₂SO₄

### SAPdepol193-4.

A solution of aq. H₂SO₄ (0.8 M, 50 mL) was prepared by adding H₂SO₄ (2.15 mL, 4.0 mmol, 1.5 equiv) to a 50-mL volumetric flask and filling to the mark with DI water.

PAA_{P&G} (250 mg, 2.70 mmol, 1.00 equiv) and aq. H₂SO₄ (0.8 M, 5 mL) were added to a 15 mL pressure vessel equipped with a stir bar followed by capping and stirring at 120° C. for the appropriate time spanning 1-24 h. Thereafter, the samples were cooled to room temperature in a water bath and quenched with aq. Na₂CO₃ (2 mL, 2M). The samples were analyzed using rheology. A pH of approximately 3 was observed using pH paper. Decrosslinking was not observed at 80° C.

The polymer solutions/gel were characterized using a 40-mm stainless steel parallel plate rheometer.

### 1.8 Decrosslinking PAA_{P&G} for Chain-Shortening Experiments

### SAPdepol186

A solution of aq. H₂SO₄ (0.8 M, 160 mL) was prepared by adding H₂SO₄ (6.84 mL, 128 mmol, 1.5 equiv) to a 350 mL pressure vessel containing DI H₂O (160 mL) stirring at 350 rpm. Thereafter, PAA_{P&G} (8,000 mg, 85.1 mmol, 1 equiv) was added followed by capping and stirring at 120° C. for 24 h. The decrosslinked polymer was used for sonication experiments (see chain-shortening sections).

After sonication, the polymer was dialyzed using DI water (1 gallon), switching the DI water three times over 12-18 h. Thereafter, the polymer was freeze-dried and ground to a fine powder using a mortar and pestle.

Grinding to powder. While wearing cryogenic gloves, a chunk of freeze-dried dried polymer was put into a mortar which was then immersed into a bath of liquid N₂. A small amount of liquid N₂ was poured into the mortar and the polymer was ground using a pestle. The fine powder was immediately transferred to a 20 mL vial and dried under high vacuum for 10 min as the polymer warmed to ambient temperature (this is to avoid condensed moisture from wetting the polymer.)

### 1.9 Monitoring Chain-Shortening Over Time of Decrosslinked PAA_{P&G} at 5.0% w/v

### SAPdepol195

Chain-shortening at 5.0%. Two portions of the decrosslinked PAA_{P&G} solution (50 mL) were poured into jacketed beakers equipped with a stir bar. While flowing cold water through the jacket the decrosslinked PAA_{P&G} was sonicated at 100% amplitude (290 W) while collecting 1.0 mL aliquots at 1, 2, 5, and 10 min. During sonication, the temperature rose from 10-15° C. to 50° C. The aliquots were quenched using aq. NaCO3 (2 M, 0.4 mL). The aliquots were diluted (to 1-1.5 mg/mL) with 0.2 M aq. NaNO₃/ethylene glycol (99:1 v/v) and analyzed via SEC.

TABLE 1
Maximum power (Pₘₐₓ) consumed
during sonication for PAA_{P&G} at 5% w/v

| | | | run 1 | run 2 |
|---|---|---|---|---|
| [PAA] | mass | | Pₘₐₓ | Pₘₐₓ |
| (w/v %) | (mg) | mmol | (W) | (W) |
| 5 | 2,500 | 26.6 | 290 | 290 |

Maximum specific energy (wₘₐₓ) values were determined using equation 1.

TABLE 2
Weight average molecular weight (M_{w}),
dispersity (Ð) and specific energy (wₘₐₓ) data for
sonications of decrosslinked PAA_{P&G} at 5.0% w/v.

| | run 1 | | | run 2 | | |
|---|---|---|---|---|---|---|
| time | M_{w} | | | M_{w} | | |
| (min) | (kg/mol) | Ð | wₘₐₓ | (kg/mol) | Ð | wₘₐₓ |
| 0 | 870 | 2.8 | | | | |
| 1 | 460 | 1.8 | 7 | 430 | 1.7 | 7 |
| 2 | 340 | 1.6 | 14 | 320 | 1.6 | 14 |
| 5 | 270 | 1.3 | 35 | 270 | 1.4 | 35 |
| 10 | 220 | 1.3 | 70 | 200 | 1.4 | 70 |

### 1.10 Monitoring Chain-Shortening Over Time of Decrosslinked PAA_{P&G} at 2.5% w/v

### SAPdepol196

A portion of the decrosslinked PAA_{P&G} solution (50 mL) was diluted to 100 mL using DI water to make 2.5% w/v solution and poured into two jacketed beakers equipped with a stir bar. While flowing cold water through the jacket, the decrosslinked PAA_{P&G} was sonicated at 100%4 amplitude (280 W) while collecting 1.0 mL aliquots at 1, 2, 5, and 10 min. During sonication, the temperature rose from 10-15° C. to 50° C. The aliquots were quenched using aq. NaCO₃ (2 M, 0.2 mL). The aliquots were diluted (to 1-1.5 mg/mL) with 0.2 M aq. NaNO₃/ethylene glycol (99:1 v/v) and analyzed via SEC.

TABLE 3
Maximum power (Pₘₐₓ) consumed
during sonication for PAA_{P&G} at 2.5% w/v

| | | | run 1 | run 2 |
|---|---|---|---|---|
| [PAA] | mass | | Pₘₐₓ | Pₘₐₓ |
| (w/v %) | (mg) | mmol | (W) | (W) |
| 2.5 | 1,250 | 13.3 | 280 | 280 |

Maximum specific energy (wₘₐₓ) values were determined using equation 1.

### 1.11 Fischer Esterification Studies

TABLE 4
Weight average molecular weight (M_{w}),
dispersity (Ð) and specific energy (wₘₐₓ) data for
sonications of decrosslinked PAA_{P&G} at 2.5% w/v.

| | run 1 | | | run 2 | | |
|---|---|---|---|---|---|---|
| time | M_{w} | | | M_{w} | | |
| (min) | (kg/mol) | Ð | wₘₐₓ | (kg/mol) | Ð | wₘₐₓ |
| 0 | 870 | 2.8 | | 870 | 2.8 | |
| 0.5 | 450 | 1.9 | 6.7 | 560 | 2.0 | 6.7 |
| 1 | 330 | 1.7 | 13 | 390 | 1.6 | 13 |
| 2 | 240 | 1.5 | 27 | 290 | 1.5 | 27 |
| 5 | 180 | 1.4 | 67 | 210 | 1.4 | 67 |
| 10 | 140 | 1.3 | 130 | 160 | 1.4 | 130 |

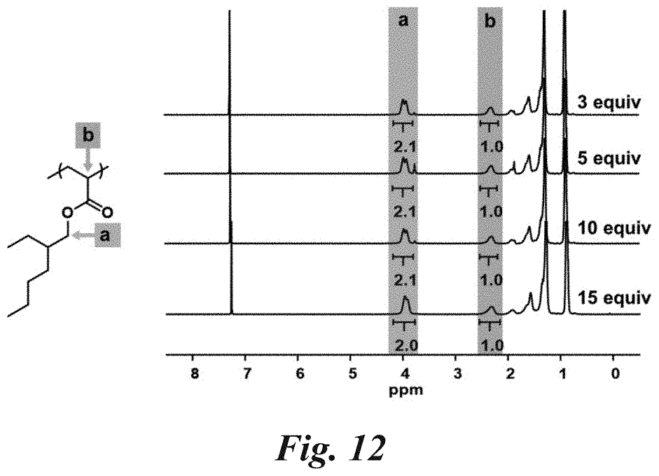

Commercial PAAs (i.e., PAA_{SIGMA1} and PAA_{SIGMA2}) come in a fine powder form and low molecular weight (<450 kg/mol) relative to the chain-shortened PAA_{SPP} and PAA_{P&G}. Consequently, the shorter esterification times were used for commercial PAAs relative to the chain-shortened materials (3-5 h for commercial PAAs versus 10 h for chain-shortened materials). High degrees of esterification were qualitatively suspected when the white heterogenous reaction mixture became clear and homogenous (see FIG. 12).

### 1.12 Effect of Alcohol Equivalents on Conversion

Reactions were run under identical conditions except for the amounts of 2-ethylhexanol (2-EHOH) (3, 5, 10, 15 equiv.) used relative to PAA. 2-EHOH (2.6 mL, 16.7 mmol, 3.00 equiv.; 4.30 mL, 27.8 mmol, 5.00 equiv.; 8.70 mL, 55.5 mmol, 10.0 equiv.; 13.0 mL, 83.3 mmol, 15.0 equiv.) was added to separate 20 mL vials equipped with stir bars. p-TsOH (527 mg, 2.80 mmol, 0.500 equiv.) was added to each vial and stirred until dissolved. The vials were subsequently heated to 120° C., then PAA_{SIGMA2} (400 mg, 5.60 mmol, 1.0 equiv.) was added. The vials were capped and stirred for 4 h at 120° C. Thereafter, the vials were cooled in a rt water bath. The poly(2-ethylhexyl acrylate)_{SIGMA2} (P(2-EHA))_{SIGMA2}) was isolated by precipitating into MeOH (10 mL) and removing the supernatant. Then, the polymer was purified by dissolving in minimal amounts of THF (1 mL), precipitating into MeOH (10 mL), and removing the supernatant. This process was repeated three times. The resulting solid was dried under high vacuum at 60° C. for 3 h.

This experiment was repeated and the isolated yields were 77% (3 equiv), 77% (5 equiv), 89% (10 equiv), and 89% (15 equiv).

### 1.13 Effect of Adding Water on Conversion

To a 15 mL pressure tube, 2-EHOH (1.95 mL, 12.5 mmol, 3.00 equiv.), DI H₂O (0.220 mL, 12.5 mmol, 3.00 equiv.) and H₂SO₄ (0.0550 mL, 1.04 mmol, 0.250 equiv.) were added and stirred at 120° C. While stirring, PAA_{SPP-20 min} (300 mg, 4.20 mmol, 1.0 equiv.) was subsequently added and the vessel was sealed and stirred for 8 h at 120° C. Thereafter, the vessels were cooled in a rt water bath. The poly(2-ethylhexyl acrylate)_{SPP-20 min} (P(2-EHA))_{SPP-2 min}) was isolated by precipitating into MeOH (10 mL) and removing the supernatant. Then, the polymer was purified by dissolving in minimal amounts of THF (1 mL), precipitating into MeOH (10 mL), and removing the supernatant. This process was repeated three times. The resulting solid was dried under high vacuum at 60° C. for 3 h.

In the replication experiment, the isolated yield was 83%.

### 1.14 Effect of Adding Water on Conversion for Small Molecule Carboxylic Acids

### SAPdepol151

(This experiment was run in duplicate.) To two 15 mL pressure tubes equipped with stir bars, 2-EHOH (3.91 mL, 25 mmol, 5.0 equiv.), sulfuric acid (0.067 mL, 1.25 mmol, 0.25 equiv.) and acetic acid (0.29 mL, 5.0 mmol, 1.0 equiv.) were added. Then, DI H₂O (0.45 mL, 25 mmol, 5.00 equiv.) was added to one vessel and both vessels were sealed and stirred at 120° C. for 8 h. Thereafter, the vessels were cooled in a it water bath and aliquots (0.1 mL) were diluted with 2:1 CDCl₃/pyridine-d₅ (0.4 mL) for ¹H NMR spectroscopic analysis.

(This experiment was run in duplicate.) To two 15 mL pressure tubes equipped with stir bars, EtOH (1.5 mL, 26 mmol, 5.1 equiv.), H₂SO₄ (0.0670 mL, 1.25 mmol, 0.245 equiv.) and acetic acid (0.29 mL, 5.1 mmol, 1.0 equiv.) were added. Then, DI H₂O (0.45 mL, 25 mmol, 4.9 equiv.) was added to one vessel and both vessels were sealed and stirred at 120° C. for 8 h. Thereafter, the vessels were cooled in a rt water bath and aliquots (0.1 mL) were diluted with 2:1 CDCl₃/pyridine-d₅ (0.4 mL) for ¹H NMR spectroscopic analysis.

To two 15 mL pressure tubes equipped with stir bars, 2-EHOH (1.8 mL, 12 mmol, 5.0 equiv.), H₂SO₄ (0.031 mL, 0.58 mmol, 0.25 equiv.) and undecanoic acid (433 mg, 2.30 mmol, 1.00 equiv.) were added. Then, DI H₂O (0.21 mL, 12 mmol, 5.0 equiv.) was added to one vessel and both vessels were sealed and stirred at 120° C. for 8 h. Thereafter, the vessels were cooled in a rt water bath and aliquots (0.1 mL) were diluted with 2:1 CDCl₃/pyridine-d₅ (0.4 mL) for ¹H NMR spectroscopic analysis.

To two 15 mL pressure tubes equipped with stir bars, 2-EHOH (1.8 mL, 12 mmol, 5.2 equiv.), H₂SO₄ (0.031 mL, 0.58 mmol, 0.25 equiv.) and decanoic acid (400 mg, 2.32 mmol, 1.00 equiv.) were added. Then, DI H-20 (0.21 mL, 12 mmol, 5.2 equiv.) was added to one vessel and both vessels were sealed and stirred at 120° C. for 8 h. Thereafter, the vessels were cooled in a rt water bath and aliquots (0.1 mL) were diluted with 2:1 CDCl₃/pyridine-

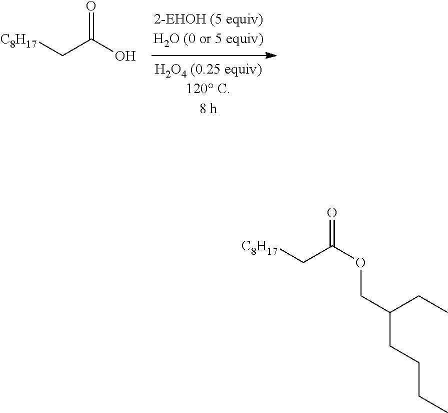

d₅ (0.4 mL) for ¹H NMR spectroscopic analysis.

### SAPdepol161

To two 15 mL pressure tubes equipped with stir bars, EtOH (0.58 mL, 9.98 mmol, 5.0 equiv), sulfuric acid (0.027 mL, 0.50 mmol, 0.25 equiv) and undecanoic acid (400 mg, 2 mmol, 1.0 equiv) were added. Then, DI H₂O (0.18 mL, 9.98 mmol, 5.0 equiv) was added to R2 and the vessels were sealed stirred at 120° C. for 8 h. Thereafter, the vessels were cooled in a rt water bath and aliquots (0.1 mL) were diluted with 2:1 CDCl₃/pyridine-d₅ (0.4 mL) for ¹H NMR spectroscopic analysis.

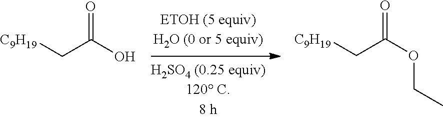

### SAPdepol172

To two 15 mL pressure tubes equipped with stir bars, EtOH (0.74 mL, 12.6 mmol, 5.0 equiv), sulfuric acid (0.034 mL, 0.63 mmol, 0.25 equiv) and undecanoic acid (470 mg, 2.52 mmol, 1.0 equiv) were added. Then, DI H₂O (0.23 mL, 12.6 mmol, 5.0 equiv) was added to R2 and the vessels were sealed stirred at 120° C. for 8 h. Thereafter, the vessels were cooled in a rt water bath and aliquots (0.1 mL) were diluted with 2:1 CDCl₃/pyridine-

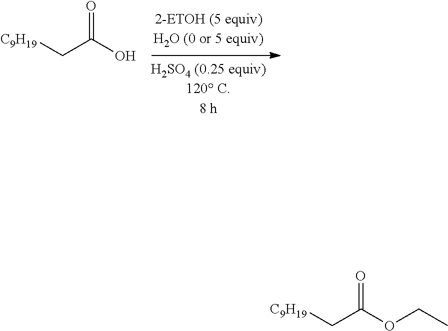

d₅ (0.4 mL) for ¹H NMR spectroscopic analysis.

### 1.15 Free-Energy Calculations

### 1.15.1 Background on Free Energy Calculations

The calculation of free-energy differences between two states is a common and widely adopted method in computational chemistry. Christ et al., 2010. To assess the difference between two states, the states must have a configurational overlap large enough for a comparison to be made. In practice, most end states do not have such an overlap, necessitating the use of bridge states that are a mix of both systems of interest. Herein the degree of perturbation is denoted as λ.

### 1.15.2 System Construction

Nonamers AA₉, BA₈AA₁, AA₈BA₁, and BA₉ were constructed using Avogadro, Hanwell et al., 2012, and then solvated in a 3:1 butanol:water cuboid using PACKMOL, Martinez et al., 2009, providing a 12 Å buffer between the nonamer and the edge of the cuboid. This resulted in a 41.841×44.981×45.167 Å box with 480 butanols and 160 waters for BA₈AA₁ and BA₉, and a 37.678×40.876×35.483 Å box with 333 butanols and 111 waters for AA₉ and AA₈BA₁. All of the nonamers studied were isotactic. TIP3P parameters, Jorgensen et al., 1983, were used for water, and parameters for butanol and the nonamers were derived from CGenFF, Vanommeslaeghe et al., 2009, using MATCH. Yesselman et al., 2012.

### 1.15.3 Molecular Dynamics

Molecular dynamics studies were performed using the CHARMM molecular mechanics platform (developmental version 44a1), Brooks et al., 2009, with the domain decomposition (DOMDEC) computational kernels on graphics processing units (GPUs). Hynninen et al., 2014. Molecular dynamics were performed using the canonical ensemble (NVT) at 298.15 K using a Langevin thermostat. The Leapfrog Verlet integrator was used with an integration time of 2 fs. Electrostatic interactions were modeled using a particle-mesh Ewald method, Darden et al., 1993; Essmann et al., 1995; Huang et al., 2016, with a grid spacing of 1 Å, interpolation order of 6, and a x-value of 0.32 Å⁻¹. Van der Waals interactions were modelled using a 9 Å switching radius, 10 Å cutoff radius, and a 12 Å neighbor list.

### 1.15.4 Calculating the Difference in Free Energy of Esterification (ΔΔA)

The difference in free energy of esterification (ΔΔA) was calculated using the Multistate Bennet Acceptance Ratio method, Shirts and Chodera, 2008, using a dual topology approach. Both AA₉ and BA₈AA₁ were perturbed to AA₈BA₁ and BA₉, respectively, using 11 discrete λ states, 0-1, in steps of Δλ=0.1. Perturbation of λ was achieved using the block module of CHARMM, λ values held constant using the MSλD ffix keyword. Vilseck et al., 2019. Non-bonding interactions were scaled by λ using a soft-core potential. Hayes et al., 2017. Prior to molecular dynamics simulations, a system was subjected to 200 steps of steepest descent minimization. Each λ state was subjected to 200 steps of steepest descent minimization, followed by equilibration for 5 ns. Production runs consisted of 50 ns of simulation, with trajectory frames saved every 2,500 timesteps (yielding 10,000 frames total).

### 1.15.5 Energy Calculation Results

The free energy difference between the λ=0 and other lambda states (0.1 to 1.0) for the AA₉ and BA₈AA₁ systems are shown in Table 5. From the ΔA value for when λ=1 for both systems, the ΔΔA of esterification is calculated to be −0.7±0.1 kcal/mol. As the consumption of butanol and the evolution of water is expected to be identical in AA₈BA₁ and BA₉, the ΔA of butanol consumption and water formation during the process of esterification was ignored, as those terms would cancel out in the calculation of ΔΔA of esterification (FIG. 3).

TABLE 5
Values for the difference in free energy between λ = 0
and other λ values for the AA₉ and BA₈AA₁ systems.

| | AA₉ → BA₈AA₁ | | BA₈AA₁ → BA₉ | |
|---|---|---|---|---|
| | ΔA relative to λ = 0 | | ΔA relative to λ = 0 | |
| λ | in k_{B}T | in kcal/mol | in k_{B}T | in kcal/mol |
| 0.0 | 0.0 ± 0.0 | 0.0 ± 0.0 | 0.0 ± 0.0 | 0.0 ± 0.0 |
| 0.1 | 22.5 ± 0.1 | 13.35 ± 0.07 | 21.2 ± 0.1 | 12.58 ± 0.06 |
| 0.2 | 36.8 ± 0.1 | 21.78 ± 0.08 | 35.1 ± 0.1 | 20.74 ± 0.06 |
| 0.3 | 48.4 ± 0.1 | 28.70 ± 0.08 | 46.4 ± 0.1 | 27.51 ± 0.06 |
| 0.4 | 58.5 ± 0.1 | 34.65 ± 0.08 | 56.4 ± 0.1 | 33.44 ± 0.06 |
| 0.5 | 67.4 ± 0.1 | 39.92 ± 0.08 | 65.4 ± 0.1 | 38.75 ± 0.06 |
| 0.6 | 75.6 ± 0.1 | 44.76 ± 0.08 | 73.7 ± 0.1 | 43.66 ± 0.06 |
| 0.7 | 83.1 ± 0.1 | 49.24 ± 0.08 | 81.4 ± 0.1 | 48.21 ± 0.06 |
| 0.8 | 90.0 ± 0.1 | 53.31 ± 0.08 | 88.4 ± 0.1 | 52.37 ± 0.06 |
| 0.9 | 96.1 ± 0.1 | 56.93 ± 0.08 | 94.7 ± 0.1 | 56.10 ± 0.06 |
| 1.0 | 101.3 ± 0.1 | 60.04 ± 0.08 | 100.2 ± 0.1 | 59.35 ± 0.06 |

### 1.16 Esterifying PAA_{P&G} Fragments to Make PSAs

### SAPdepol192

PAA_{P&G_5%-0 min}. To a 75 mL pressure vessel, 2-EHOH (3.80 mL, 24.3 mmol, 5.00 equiv.) and H₂SO₄ (0.065 mL, 1.21 mmol, 0.25 equiv.) were added and stirred at 120° C. While stirring, PAA_{P&G_5%-0 min} (350 mg, 4.90 mmol, 1.00 equiv.) was subsequently added and the vessel was sealed and stirred for 10 h at 120° C. Thereafter, the vessel was cooled in a rt water bath. The poly(2-ethylhexyl acrylate)_{P&G-0 min} ((P(2-EHA))_{P&G_5%-0 min}) was isolated by precipitating into MeOH (20 mL) and removing the supernatant. Then, the polymer was purified by dissolving in minimal amounts of THF (5 mL), precipitating into MeOH (20 mL), and removing the supernatant. This process was repeated three times. The resulting solid was dried under high vacuum at 80° C. for 10 h. The isolated yield was 81%. A portion of the P(2-EHA)_{P&G_5%-0 min} (600 mg) was used for frequency sweep measurements.

### SAPdepol188

P(2-EHA)_{P&G_5%-2 min}. To a 75 mL pressure vessel, 2-EHOH (4.34 mL, 27.8 mmol, 5.00 equiv.) and H₂SO₄ (0.074 mL, 1.39 mmol, 0.25 equiv.) were added and stirred at 120° C. While stirring, PAA_{P&G_5%-2 min} (400 mg, 5.60 mmol, 1.00 equiv.) was subsequently added and the vessel was sealed and stirred for 10 h at 120° C. Thereafter, the vessel was cooled in a rt water bath. The poly(2-ethylhexyl acrylate)_{P&G_5%-2 min} ((P(2-EHA))_{P&G_5%-2 min}) was isolated by precipitating into MeOH (20 mL) and removing the supernatant. Then, the polymer was purified by dissolving in minimal amounts of THF (5 mL), precipitating into MeOH (20 mL), and removing the supernatant. This process was repeated three times. The resulting solid was dried under high vacuum at 80° C. for 10 h. The isolated yield was 78%. A portion of the P(2-EHA)_{P&G_5%-2 min} (600 mg) was used for frequency sweep measurements.

### SAPdepol187

P(2-EHA))_{P&G_5%-5 min}. To a 75 mL pressure vessel, 2-EHOH (6.51 mL, 41.6 mmol, 5.00 equiv.) and H₂SO₄ (0.111 mL, 2.08 mmol, 0.25 equiv.) were added and stirred at 120° C. While stirring, PAA_{P&G_5%-5 min} (600 mg, 10.4 mmol, 1.0 equiv.) was subsequently added and the vessel was sealed and stirred for 10 h at 120° C. Thereafter, the vessel was cooled in a rt water bath. The poly(2-ethylhexyl acrylate)_{P&G_5%-5 min} ((P(2-EHA))_{P&G_5%-5 min}) was isolated by precipitating into MeOH (20 mL) and removing the supernatant. Then, the polymer was purified by dissolving in minimal amounts of THF (5 mL), precipitating into MeOH (20 mL), and removing the supernatant. This process was repeated three times. The resulting solid was dried under high vacuum at 80° C. for 10 h. The isolated yield was 76%. A portion of the P(2-EHA)_{P&G_5%-5 min} (600 mg) was used for frequency sweep measurements.

### SAPdepol190

P(2-EHA)_{P&G_2.5%-1 min}. To a 75 mL pressure vessel, 2-EHOH (6.51 mL, 41.6 mmol, 5.00 equiv.) and H₂SO₄ (0.111 mL, 2.08 mmol, 0.25 equiv.) were added and stirred at 120° C. While stirring, PAA_{P&G_2.5%-1 min} (600 mg, 10.4 mmol, 1.0 equiv.) was subsequently added and the vessel was sealed and stirred for 10 h at 120° C. Thereafter, the vessel was cooled in a rt water bath. The poly(2-ethylhexyl acrylate)_{P&G_2.5%-1 min} ((P(2-EHA))_{P&G_2.5%-1 min}) was isolated by precipitating into MeOH (20 mL) and removing the supernatant. Then, the polymer was purified by dissolving in minimal amounts of THF (5 mL), precipitating into MeOH (20 mL), and removing the supernatant. This process was repeated three times. The resulting solid was dried under high vacuum at 80° C. for 10 h. The isolated yield 73%. A portion of the P(2-EHA)_{P&G_2.5%-1 min} (600 mg) was used for frequency sweep measurements.

### SAPdepol192

PAA_{P&G_5%-0 min}. To a 75 mL pressure vessel, 2-EHOH (3.80 mL, 24.3 mmol, 5.00 equiv.) and H₂SO₄ (0.065 mL, 1.21 mmol, 0.25 equiv.) were added and stirred at 120° C. While stirring, PAA_{P&G_5%-0 min} (350 mg, 4.90 mmol, 1.00 equiv.) was subsequently added and the vessel was sealed and stirred for 10 h at 120° C. Thereafter, the vessel was cooled in a rt water bath. The poly(2-ethylhexyl acrylate)_{P&G_5%-0 min} ((P(2-EHA))_{P&G_5%-0 min}) was isolated by precipitating into MeOH (20 mL) and removing the supernatant. Then, the polymer was purified by dissolving in minimal amounts of THF (5 mL), precipitating into MeOH (20 mL), and removing the supernatant. This process was repeated three times. The resulting solid was dried under high vacuum at 80° C. for 10 h. The isolated yield was 81%. A portion of the P(2-EHA)_{P&G_5%-0 min} (600 mg) was used for frequency sweep measurements.

### SAPdepol188

P(2-EHA)_{P&G_5%-2 min}. To a 75 mL pressure vessel, 2-EHOH (4.34 mL, 27.8 mmol, 5.00 equiv.) and H₂SO₄ (0.074 mL, 1.39 mmol, 0.25 equiv.) were added and stirred at 120° C. While stirring, PAA_{P&G_5%-2 min} (400 mg, 5.60 mmol, 1.00 equiv.) was subsequently added and the vessel was sealed and stirred for 10 h at 120° C. Thereafter, the vessel was cooled in a rt water bath. The poly(2-ethylhexyl acrylate)_{P&G_5%-2 min} ((P(2-EHA))&G 5%-2 min) was isolated by precipitating into MeOH (20 mL) and removing the supernatant. Then, the polymer was purified by dissolving in minimal amounts of THF (5 mL), precipitating into MeOH (20 mL), and removing the supernatant. This process was repeated three times. The resulting solid was dried under high vacuum at 80° C. for 10 h. The isolated yield was 78%. A portion of the P(2-EHA)_{P&G_5%-2 min} (600 mg) was used for frequency sweep measurements.

### SAPdepol187

P(2-EHA))_{P&G_5%-5 min}. To a 75 mL pressure vessel, 2-EHOH (6.51 mL, 41.6 mmol, 5.00 equiv.) and H₂SO₄ (0.111 mL, 2.08 mmol, 0.25 equiv.) were added and stirred at 120° C. While stirring, PAA_{P&G_5%-5 min} (600 mg, 10.4 mmol, 1.0 equiv.) was subsequently added and the vessel was sealed and stirred for 10 h at 120° C. Thereafter, the vessel was cooled in a rt water bath. The poly(2-ethylhexyl acrylate)_{P&G_5%-5 min} ((P(2-EHA))_{P&G_5%-5 min}) was isolated by precipitating into MeOH (20 mL) and removing the supernatant. Then, the polymer was purified by dissolving in minimal amounts of THF (5 mL), precipitating into MeOH (20 mL), and removing the supernatant. This process was repeated three times. The resulting solid was dried under high vacuum at 80° C. for 10 h. The isolated yield was 76%. A portion of the P(2-EHA)_{P&G_5%-5 min} (600 mg) was used for frequency sweep measurements.

### SAPdepol190

P(2-EHA)_{P&G_2.5%-1 min}. To a 75 mL pressure vessel, 2-EHOH (6.51 mL, 41.6 mmol, 5.00 equiv.) and H₂SO₄ (0.111 mL, 2.08 mmol, 0.25 equiv.) were added and stirred at 120° C. While stirring, PAA_{P&G_2.5%-1 min} (600 mg, 10.4 mmol, 1.0 equiv.) was subsequently added and the vessel was sealed and stirred for 10 h at 120° C. Thereafter, the vessel was cooled in a rt water bath. The poly(2-ethylhexyl acrylate)_{P&G_2.5%-1 min} ((P(2-EHA))_{P&G_2.5%-1 min}) was isolated by precipitating into MeOH (20 mL) and removing the supernatant. Then, the polymer was purified by dissolving in minimal amounts of THF (5 mL), precipitating into MeOH (20 mL), and removing the supernatant. This process was repeated three times. The resulting solid was dried under high vacuum at 80° C. for 10 h. The isolated yield 73%. A portion of the P(2-EHA)_{P&G_2.5%-1 min} (600 mg) was used for frequency sweep measurements.

A life cycle assessment (LCA) was applied to evaluate the environmental impacts of these novel repurposing methods in comparison to business-as-usual production of Poly(2-ethylhexyl acrylate) (P(2-EHA)).

### 1.17 Methods

Modeling of different disposal scenarios was done using the software SimaPro version 9.0.0.48 and the ecoinvent database version 3.5, Wernet et al., 2016, and impacts were calculated using the ReCiPe 2016 v1.1 midpoint method, hierarchist version. LCIA. Processes and material production were assumed to take place in the US and therefore all ecoinvent processes were specific to a US scenario. LCA results for all impact categories are reported, paying specific attention to cumulative energy demand (CED) and global warming potential (GWP).

### 1.18 Goal and Scope

The main goal of the LCA was to quantify the potential environmental impacts of the novel recovery processes and compare them to production of P(2-EHA). Four total scenarios were investigated: 1) the reference scenario of P(2-EHA) production from ethanol and acrylic acid, 2) hydrolysis of reused superabsorbent poly(acrylic acid) with sonication for 1 minute followed by esterification 3) hydrolysis of reused superabsorbent poly(acrylic acid) with sonication for 2 minute followed by esterification, and 4) hydrolysis with no sonication, followed by esterification. For scenarios 2-4, we assume that superabsorbent poly(acrylic acid) is recovered from used diapers. Given the hypothetical nature of this LCA, we did not take impacts regarding transportation or distribution of the recovered superabsorbent poly(acrylic acid) or any other materials into account. In this LCA, the functional unit is 5000 mg of P(2-EHA). The inventory data for the sonication and no-sonication processes are specific to the production of 5000 mg of P(2-EHA); therefore, we compare these scenarios to business-as-usual production of 5000 mg of P(2-EHA).

### 1.19 Inventory Data

The following tables contain the inputs for the LCA scenarios. Energy to model the 2-ethylhexanol to produce P(2-EHA) and the 2-ethylhexanol used in the sonication and no sonication scenarios was taken from Poulikidou et al., 2019, given the absence of data in ecoinvent. In the P(2-EHA) scenario, we calculate that 391 g of acrylic acid are required in tandem with 1 kg 2-ethylhexanol (1000 grams) to produce P(2-EHA) based on the relative composition of P(2-EHA). In the sonication and no-sonication scenarios, we assume that the excess of the 5-equivalents of 2-ethylhexanol used is recoverable and therefore only included the emissions associated with the use of I-equivalent of 2-ethylhexanol. Importantly, given the energy required in 2-ethylhexanol production, failure to re-use 2-ethylhexanol will likely favor business-as-usual production of (P-2EHA) over the repurposing scenarios. Emissions data for the extraction of superabsorbent poly(acrylic acid) from diapers was taken from a recent LCA of novel diaper recycling technology in Japan. Itsubo et al., 2020. We account for the collection, separation, wastewater treatment, organic acid recovery, and ozone treatment required to recover (approximately 80%) of the superabsorbent poly(acrylic acid) in one diaper. Since LCA data for these steps was reported per diaper, we multiplied each value by 19%, the percent composition of superabsorbent poly(acrylic acid). These numbers were then adjusted to account for 80% recovery (i.e., per 9.04 g superabsorbent poly(acrylic acid) not the 11.3 g superabsorbent poly(acrylic acid) in a diaper before recycling). Lastly, to account for the lyophilization of superabsorbent poly(acrylic acid) after immediate extraction, we included data from a lyophilization LCA. Prosapio et al., 2017.

TABLE 6
Inventory data for reference P(2-EHA scenario)

| Material | Amount | | Comments |
|---|---|---|---|
| Poly(2-Ethylhexyl Acrylate)* | 5000 | mg | |
| *modeled as follows; per 1 kg | | | |
| P(2-EHA) | | | |
| Electricity, US grid | 117 | MJ | Taken from Poulikidou et al., |
| | | | 2019 (17) |
| Acrylic Acid | 391 | g | Required acrylic acid to make |
| | | | 1 kg P(2-EHA) based on fraction |
| | | | of acrylic acid in P(2-EHA) |

TABLE 7
Inventory data for Sonication scenario.

| Material | Amount | | Comments |
|---|---|---|---|
| Sulfuric acid for protonation and | 3.91 | g | |
| decrosslinking | | | |
| Sulfuric acid for esterification | 0.65 | g | |
| 2-Ethylhexanol ^{a} | 0.00346 | kg | 1 equivalent. Assuming remainder |
| | | | recycled |
| Electricity, low voltage, US grid | 34.8 | kJ | For sonication 2 min scenario: 2 |
| for sonication | | | minutes, 290 watts |
| or ---> | 33.6 | kJ | For sonication 1 min scenario: 1 |
| | | | minute, 280 watts |
| Electricity, low voltage, US grid | 20.92 | kJ | |
| for decrosslinking heat | | | |
| Electricity, low voltage, US grid | 2.976 | kJ | |
| for esterification heat | | | |
| Superabsorbent Poly(acrylic | 2500 | mg | |
| acid) extraction ^{b} | | | |
| Lyophilization ^{c} | 50 | g | |
| ^{a} modeled as follows; per 1 kg | | | Taken from Poulikidou et ak, 2019 |
| 2-Ethylhexanol | | | (17) |
| Electricity, US grid | 117 | MJ | |
| ^{b} modeled as follows; per 9.04 | | | Taken from Itsubo et al., 2019 (18) |
| grams of superabsorbent | | | |
| poly(acrylic acid) (80% | | | |
| recovery from 1 diaper) | | | |
| Land use | 7.9 | cm²a | |
| CO2eq | 6.8 | g | |
| Water | 0 22 | m³ | |
| ^{c} modeled as follows; per | | | Taken from Prosapio et al., 2017 (19) |
| 2.43 kg of water | | | |
| Electricity, US grid | 1.98E−01 | | |
| Electricity, US grid | 4.36E−01 | | |
| Electricity, US grid | 2.67E−01 | | |
| Wastewater to treatment | 2437 | cm³ | |

TABLE 8
Inventory data for No Sonication scenario.

| Material | Amount | | Comments |
|---|---|---|---|
| Sulfuric add for protonation | 3.91 | g | |
| and decrosslinking | | | |
| Sulfuric acid for esterification | 0.65 | g | |
| 2-Ethylhexanol ^{a} | 0.00346 | kg | 1 equivalent. Assuming remainder |
| | | | recycled |
| Electricity, low voltage, US grid | 20.92 | kJ | |
| for decrosslinking heat | | | |
| Electricity, low voltage, US grid | 2.976 | kJ | |
| for esterification heat | | | |
| Superabsorbent Poly(acrylic | 2500 | mg | |
| acid) extraction ^{b} | | | |
| Lyophilization ^{c} | 50 | g | |
| ^{a} modeled as follows; per 1 | | | Taken from Poulikidou et al., 2019 |
| kg 2-Ethylhexanol | | | (17) |
| Electricity, US grid | 117 | MJ | |
| ^{b} modeled as follows; per | | | Taken from Itsubo et al., 2019 (18) |
| 9.04 grams of superabsor- | | | |
| bent poly(acrylic acid) (80% | | | |
| recovery from 1 diaper) | | | |
| Land use | 7.9 | cm²a | |
| CO2eq | 6.8 | g | |
| Water | 0.22 | m³ | |
| ^{c} modeled as follows; per | | | Taken from Prosapio et al., 2017 (19) |
| 2.43 kg of water removed | | | |
| Electricity, US grid | 1.98E−01 | | |
| Electricity, US grid | 4.36E−01 | | |
| Electricity, US grid | 2.67E−01 | | |
| Wastewater to treatment | 2437 | cm³ | |

### 1.20 Results

Provided in Table 9 are impact assessment results for all four scenarios. Conditional formatting is applied for ease of comparison.

TABLE 9
Impact Assessments

| | | Conventional | 2.5%, | 5%, | 5%, |
|---|---|---|---|---|---|
| Impact category | Unit | P(2-EHA) | 1 minute | 2 minutes | 0 minutes |
| Non renewable fossil | MJ | 1.556694552 | 1.247920143 | 1.251188575 | 1.156404015 |
| Non renewable nuclear | MJ | 0.535591329 | 0.453690083 | 0.454889638 | 0.42010254 |
| Non renewable biomass | MJ | 2.96379E−07 | 2.49483E−07 | 2.50179E−07 | 2.30006E−07 |
| Renewable biomass | MJ | 0.021879493 | 0.018504581 | 0.018555543 | 0.017077648 |
| Renewable wind solar geothe | MJ | 0.002552803 | 0.002134531 | 0.002140195 | 0.001975943 |
| Renewable water | MJ | 0.047954448 | 0.04050991 | 0.040618577 | 0.037467259 |
| CED | MJ | 2.164672921 | 1.762759498 | 1.767392778 | 1.633027636 |
| Global warming | kg CO2 eq | 0.129042101 | 0.110417452 | 0.11070209 | 0.1024476 |
| Stratospheric ozone depletion | kg CFC11 eq | 3.51866E−08 | 3.10588E−08 | 3.11586E−08 | 2.82645E−08 |
| Ionizing radiation | kBq Co-60 eq | 0.001202055 | 0.001013104 | 0.001015789 | 0.000937937 |
| Ozone formation Human health | kg NOx eq | 0.000241097 | 0.000207299 | 0.000207838 | 0.000192199 |
| Fine particulate matter formation | kg PM2.5 eq | 0.000222711 | 0.00019508 | 0.000195588 | 0.00018085 |
| Ozone formation Terrestrial eco- | kg NOx eq | 0.000243868 | 0.000209367 | 0.000209912 | 0.000194113 |
| systems | | | | | |
| Terrestrial acidification | kg SO2 eq | 0.000737427 | 0.000647134 | 0.000648812 | 0.000600155 |
| Freshwater eutrophication | kg P eq | 7.36346E−06 | 6.48793E−06 | 6.50878E−06 | 5.90434E−06 |
| Marine eutrophication | kg N eq | 4.70191E−07 | 7.06484E−07 | 7.07615E−07 | 6.74833E−07 |
| Terrestrial ecotoxicity | kg 1,4-DCB | 0.046799908 | 0.049981209 | 0.050337393 | 0.04000806 |
| Freshwater ecotoxicity | kg 1,4-DCB | 7.59958E−05 | 7.01696E−05 | 7.03631E−05 | 6.47516E−05 |
| Marine ecotoxicity | kg 1,4-DCB | 0.000133889 | 0.000125137 | 0.000125572 | 0.000112969 |
| Human carcinogenic toxicity | kg 1,4-DCB | 0.000396453 | 0.000471751 | 0.000475466 | 0.000367733 |
| Human non carcinogenic toxicity | kg 1,4-DCB | 0.01397052 | 0.012644896 | 0.012686979 | 0.011466569 |
| Land use | m2a crop eq | 0.001133607 | 0.000967686 | 0.000970371 | 0.000892523 |
| Mineral resource scarcity | kg Cu eq | 8.76709E−05 | 8.07441E−05 | 8.11864E−05 | 6.83599E−05 |
| Fossil resource scarcity | kg oil eq | 0.033915984 | 0.027182471 | 0.027253659 | 0.025189219 |
| Water consumption | m3 | 0.47640697 | 0.466340753 | 0.467425176 | 0.435976903 |

LCA results indicate that the PSA repurposing scenarios show improvement in almost all LCA impact categories. Moderate decreases in GWP and CED are indicated for the two sonication scenarios in comparison to conventional P(2-EHA) (approximately 13% reduction in GWP and approximately 18% reduction in CED). The no sonication scenario (5%, 0 min) outperforms the sonication scenarios, unsurprisingly, given the reduction in electricity required for the production of PSA. The no sonication scenario improves on the decreases in GWP and CED shown in the sonication scenarios; approximately 20% reduction in GWP and approximately 25% reduction in CED compared to conventional P(2-EHA).

### Example 2

### One-Pot Synthesis of Pressure-Sensitive Adhesives Combining Protonation, Decrosslinking, and Esterification

### 2.1 Experimental Methods and Representative Results

2-ethylhexanol (6.65 mL, 42.5 mmol, 8.00 equiv) and PAA_{P&G} (500 mg, 5.30 mmol, 1.00 equiv) were each added to four 15-mL pressure vessels equipped with stir bars. The top was capped with a septum and the contents were bubbled with N₂ for 20 min using a long needle. Thereafter, ethanol (0.620 mL, 10.6 mmol, 2.0 equiv) and sulfuric acid (0.567 mL, 10.6 mmol, 2.0 equiv) were added. The vessels were placed onto a heating block at 130° C. and left to stir at 350 rpm. The reaction vessels were quenched at varying time points (1.5 h, 5 h, 9 h, and 21 h).

2-ethylhexanol (13.3 mL, 85.1 mmol, 8.00 equiv) and PAA_{P&G} (1000 mg, 10.6 mmol, 1.00 equiv) were each added to a 75-pressure vessel equipped with a stir bar. The vessel was covered with aluminum foil and the contents were bubbled with N₂ for 20 min using a long needle. Thereafter, ethanol (1.24 mL, 21.3 mmol, 2.00 equiv) and sulfuric acid (1.13 mL, 21.3 mmol, 2.00 equiv) were added. The vessels were placed onto a heating block at 130° C. and left to stir at 350 rpm. The reactions were quenched at varying time points (i.e., 15 h and 25 h).

Thereafter, the vessels were cooled in a rt water bath. The polymer was isolated by precipitating into MeOH (10-20 mL) followed by centrifugation at 4500 rpm for 5 min and decanting off the supernatant. To the precipitated polymer, warm DI water (30 mL, 80° C.) was added followed by capping and vigorously handshaking (3 shakes per second) for 30 s to wash off the NaHSO₄ by-product. This process was repeated 3 times. After the final wash, a pH paper reading of the water changed from about 1 to 4. The polymer was washed with methanol (20 mL) to remove the H₂O. Further purification was done by dissolving/swelling the polymer in minimal amounts of THF (15 mL) and precipitating with MeOH (30 mL) twice. The polymer was dried under high vacuum at 100° C. for 3-5 h. 600 mg of each polymer was used for rheological measurements.

TABLE 10
Recoveries for one-pot esterifications at different timepoints.

| | | | | | | |
|---|---|---|---|---|---|---|
| reaction time (h) | 1.5 | 5 | 9 | 15 | 21 | 25 |
| recovered mass (g) | 0.65 | 0.84 | 0.88 | 1.90 | 0.89 | 1.84 |
| % recovery | 66 | 85 | 89 | 96 | 91 | 93 |

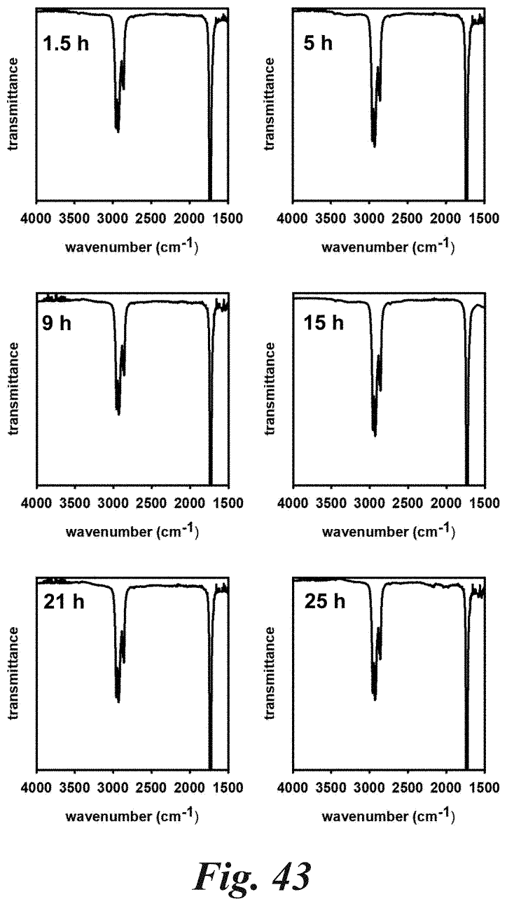

Decrosslinking/esterification was used to convert PAA_{P&G} into pressure sensitive adhesives in one pot. Data was collected for reactions run for various time points up to 25 h. Due to their hardness, samples run for times below 9 h were not characterized via rheology. All samples were characterized via IR (see FIG. 43).

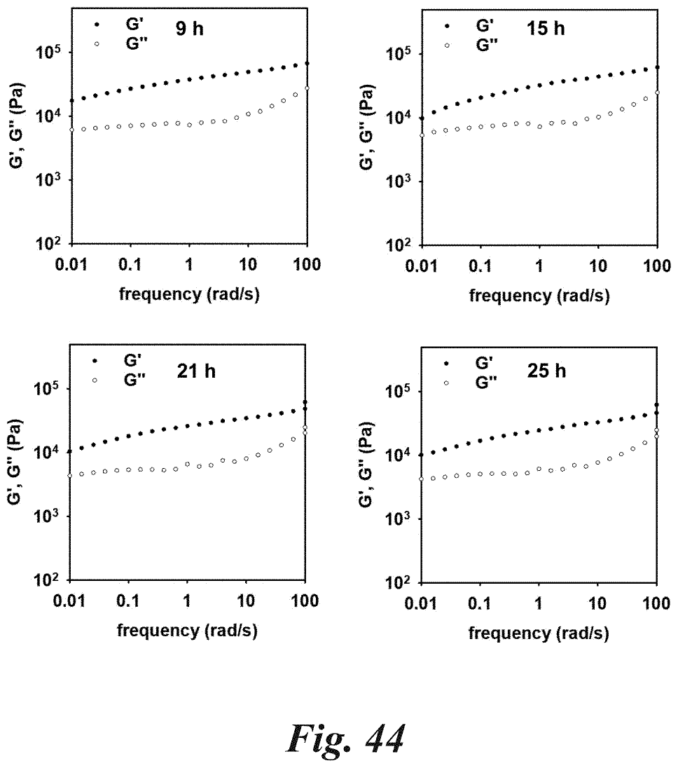

Frequency sweeps (0.01-100 Hz) were done at 25° C. using a 20-mm cross-hashed geometry using a gap of 1250 μm (600 mg of polymer) (see FIG. 44). Due to their hardness at 25° C., samples run for times below 9 h were not characterized via rheology.

### 2.2 Discussion

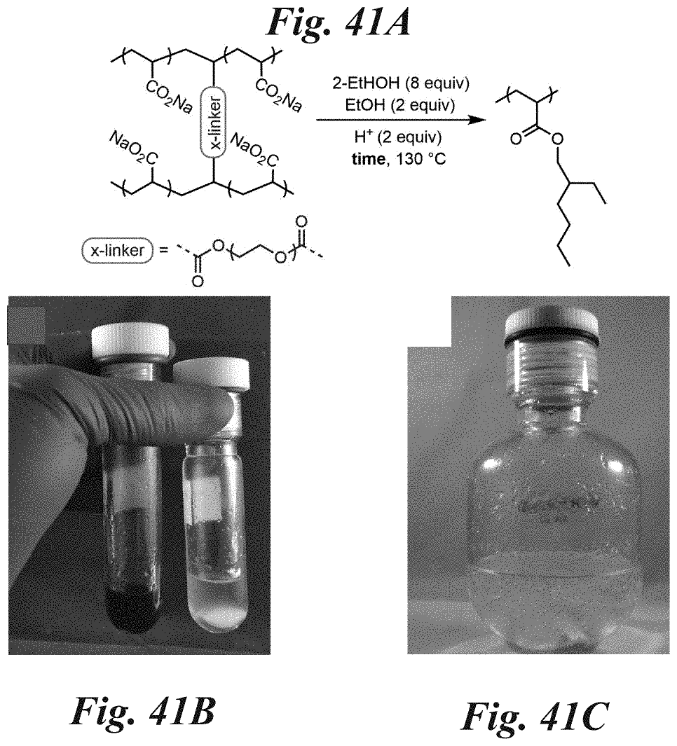

Initially, a method for esterifying PAA_{P&G} with 2-ethylhexanol (8 equiv) and sulfuric acid (2 equiv) at 130° C. was investigated, but the reaction gradually turned black (FIG. 41B, left). It was suspected that the oxidation of reagents by sulfuric acid was responsible for the observed color change. Purging the reaction with nitrogen did not remove the suspected oxidation side reactions. Based on this observation, it was thought that the crystalline and oleophobic state of PAA_{P&G} impeded 2-ethylhexanol from penetrating. Therefore, in addition to purging with nitrogen, ethanol (2 equiv) was added and the one-pot synthesis of PSA was achieved within 24 h.

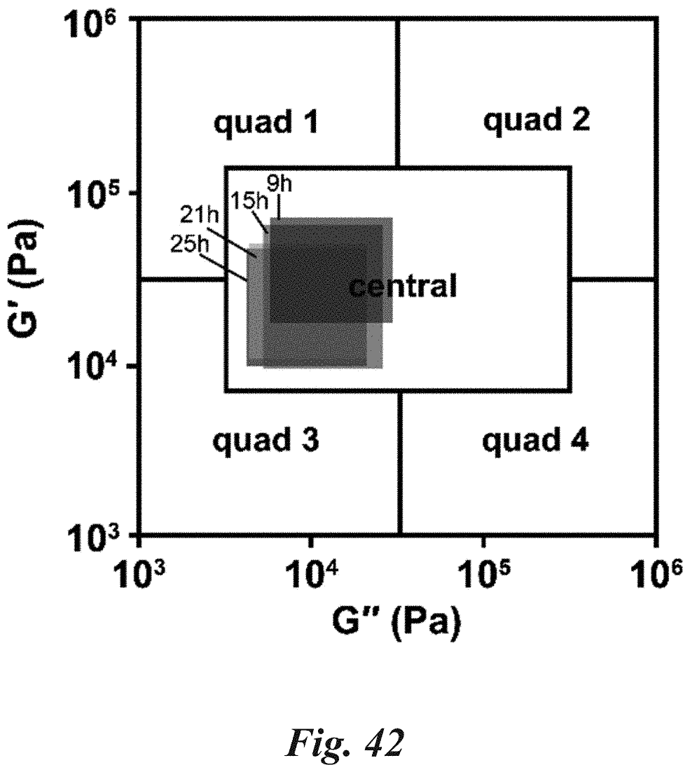

This one-pot method was further tested by evaluating the adhesive product's viscoelastic properties (i.e., G′ and G″ as a function of frequency) at different time points (i.e., 9, 15, 21, and 25 h). All of the adhesive products resided in the central portion of Chang's viscoelastic window, and no significant changes were observed in the viscoelastic properties after 15 h of esterifying (FIG. 42).

### REFERENCES

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents form part of the common general knowledge in the art. In case of a conflict between the specification and any of the incorporated references, the specification (including any amendments thereof, which may be based on an incorporated reference), shall control. Standard art-accepted meanings of terms are used herein unless indicated otherwise. Standard abbreviations for various terms are used herein.
statista.com/statistics/282732/global-production-of-plastics-since-1950 (Accessed Apr. 6, 2020)
Geyer, R.; Jambeck, J. R.; Law, K. L. Production, Use, and Fate of All Plastics Ever Made. Sci. Adv. 2017, 3, 1-6.
Advancing Sustainable Materials Management, 2017 fact sheet (EPA 530-F-19-007); United States Environmental Protection Agency (EPA)—Office of Land and Emergency Management. (5306P), 2019. epa.gov/sites/production/files/2019-11/documents/2017_facts_and_figures_fact_sheet_final.pdf
Plastics and the Environment; Andrady, A. L., Ed.; John Wiley & Sons, Inc.: Hoboken, N.J., USA, 2003.
Rochman, C. M. Microplastics Research—from Sink to Source. Science. Apr. 6, 2018, pp 28-29.
Barnes, D. K. A.; Galgani, F.; Thompson, R. C.; Barlaz, M. Accumulation and Fragmentation of Plastic Debris in Global Environments. Philos. Trans. R. Soc. B Biol. Sci. 2009, 364, 1985-1998.
Fagnani, D. E.; Tami, J. L.; Copley, G.; Clemons, M. N.; Getzler, Y. D. Y. L.-McNeil, A. J. 100th Anniversary of Macromolecular Science Viewpoint: Redefining Sustainable Polymers. ACS Macro Lett. 2021, 10, 41-53.
Advancing Sustainable Materials Management: 2017 Fact Sheet. (EPA 530-F-19-001), November 2019. 11/documents/2017_facts_and_figures_fact_sheet_final.pdf (accessed Apr. 6, 2021).
Hong, M.; Chen, E. Y.-X. Chemically Recyclable Polymers: A Circular Economy Approach to Sustainability. Green Chem. 2017, 19, 3692-3706.
Rahimi, A.; Garcia, J. M. Chemical Recycling of Waste Plastics for New Materials Production. Nat. Rev. Chem. 2017, 1, 46.
Thiounn, T.; Smith, R. C. Advances and Approaches for Chemical Recycling of Plastic Waste. J. Polym. Sci. 2020, 58, 1347-1364.
Coates, G. W.; Getzler, Y. D. Y. L. Chemical Recycling to Monomer for an Ideal, Circular Polymer Economy. Nat. Rev. Mater. 2020
Ellen MacArthur Foundation. The new plastics economy: rethinking the future of plastics & catalyzing action. Ellen MacArthur Foundation, 2017. ellenmacarthurfoundation.org/publications/the-new-plastics-economy-rethinking-the-future-of-plastics-catalysing-action (accessed on Apr. 6, 2021).
Future Market Insights (FMI). Super Absorbent Polymer (SAP) Market-Global Industry Analysis, Size and Forecast, 2015 to 2020. futuremarketinsights.com/reports/super-absorbent-polymer-market (accessed Mar. 21, 2020).
Khoo, S. C.; Phang, X. Y.; MinNg, C.; LokeLim, K.; Lam, S. S.; LingMa, N., Recent technologies for treatment and recycling of used disposable baby diapers. Process Safe-ty and Environmental Protection 2019, 123, 116-129.
Liang, L.; Li, C.; He, Q.; Tachea, F.; Tanjore, D.; Luong, T.; Somma, M.; D'Alessio, N.; Pray, T. R.; Sun, N. Upgrading of Postconsumer Absorbent Hygiene Products for Bioethanol Production. ACS Sustain. Chem. Eng. 2018, 6, 3589-3595.
Ichiura, H.; Nakaoka, H.; Konishi, T. Recycling Disposable Diaper Waste Pulp After Dehydrating the Superabsorbent Polymer Through Oxidation Using Ozone. J. Clean. Prod. 2020, 276, 123350.
McNeill, I. C.; Sadeghi, S. M. T. Thermal Stability and Degradation Mechanisms of Poly(Acrylic Acid) and Its Salts: Part 1-Poly(Acrylic Acid). Polym. Degrad. Stab. 1990, 29, 233-246.
Lépine, L.; Gilbert, R. Thermal Degradation of Polyacrylic Acid in Dilute Aqueous Solution. Polym. Degrad. Stab. 2002, 75, 337-345.
Ching, T. W.; Zhang, J.; Collias, D.; McDaniel, J.; Simonyan, A.; Tanksale, A.; Banaszak Holl, M. M. ACS Sustainable Chem. Eng. 2020, 8, 14504-14510.
Tang, H.; Luan, Y.; Yang, L.; Sun, H. A Perspective on Reversibility in Controlled Polymerization Systems: Recent Progress and New Opportunities. Molecules 2018, 23, 2870.
Zekry, M.; Nassar, I.; Salim, H.; Abdallah, A. The Potential of Superabsorbent Polymers from Diaper Wastes to Enhance Water Retention Properties of the Soil. Soil & Environ. 2020, 39, 27-37.
Al-Jabari, M.; Abu Ghyadah, R.; Alokely, R. Recovery of Hydrogel from Baby Diaper Wastes and its Application for Enhancing Soil Irrigation Management. J. Environ. Manag. 2019, 239, 255-261.
alliedmarketresearch.com/pressure-sensitive-adhesives-market (Accessed Apr. 7, 2021)
Creton, C. Pressure-Sensitive Adhesives: An Introductory Course. MRS Bull. 2003, 28, 434-439.
For example, see: Fornof, A. R.; DiZio, J. P. Self-Wetting Adhesive Composition. U.S. Pat. No. 9,822,286. Nov. 21, 2017.
Pocious, A. V. Adhesion and Adhesives Technology, 3rd ed.; Carl Hanser Verlag: Munich, 2012.
Lehmann, A. Glacial acrylic acid (GAA), Methyl acrylate (MA), Ethyl acrylate (EA), n-Butyl acrylate (BA) and 2-Ethylhexyl acrylate (2-EHA) EABM July 15; Cefic European Basic Acrylic Monomers Sector group (EBAM): Brussels, 2015; 17. petrochemistry.eu/wp-content/uploads/2018/01/150727_EBAM-Eco-profile-Acrylic-Monomers-1.pdf.
Bjørn, A.; Owsianiak, M.; Molin, C.; Laurent, A. Main characteristics of LCA. In Life Cycle Assessment; Hauschild, M. Z., Rosenbaum, R. K., Olsen, S. I., Eds.; Springer International Publishing AG: Switzerland, 2018; pp 9-16.
Takaya, C. A.; Cooper, I.; Berg, M.; Carpenter, J.; Muir, R.; Brittle, S.; Sarker, D. K. Offensive Waste Valorisation in the UK: Assessment of the Potentials for Absorbent Hygiene Product (AHP) Recycling. Waste Management 2019, 88, 56-70.
FaterSMART fatersmart.com/ (Accessed on Apr. 6, 2021).
Caruso, M. M.; Davis, D. A.; Shen, Q.; Odom, S. A.; Sottos, N. R.; White, S. R.; Moore, J. S. Mechanically-Induced Chemical Changes in Polymeric Materials. Chem. Rev. 2009, 109, 5755-5798.
Li, J.; Nagamani, C.; Moore, J. S. Polymer Mechanochemistry: From Destructive to Productive. Acc. Chem. Res. 2015, 48, 2181-2190.
Prajapat, A. L.; Gogate, P. R. Intensification of Depolymerization of Polyacrylic Acid Solution Using Different Approaches Based on Ultrasound and Solar Irradiation with Intensification Studies. Ultrason. Sonochem. 2016, 32, 290-299.
Chubarova, E. V.; Melenevskaya, E. Y.; Shamanin, V. V. Chain Degradation under Low-Intensity Sonication of Polymer Solutions in the Presence of Filler: Mechanism of Ultrasonic Degradation of Flexible Chain Macromolecules. J. Macromol. Sci. Part B 2013, 52, 873-896.
Tobing, S. D.; Klein, A. Molecular Parameters and Their Relation to the Adhesive Performance of Acrylic Pressure-Sensitive Adhesives. J. Appl. Polym. Sci. 2001, 79, 2230-2244.
Collias, D. I. et al. Depolymerization of polymers. U.S. Patent Application Publication No. 2021/0054161 A1 (Feb. 25, 2021).
Li, Q.; Bao, Y., Wang, H.; Du, F.; Li, Q.; Jin, B.; Bai, R. A Facile and Highly Efficient Strategy for Esterification of Poly(Meth)Acrylic Acid with Halogenated Compounds at Room Temperature Promoted by 1,1,3,3-Tetramethylguanidine. Polym. Chem. 2013, 4, 2891-2897.
Bauer, W. Acrylic Acid and Derivatives. In Kirk-Othmer Encyclopedia of Chemical Technology; John Wiley & Sons, Inc.: Hoboken, N.J., USA, 2003.
Ohara, T.; Sato, T.; Shimizu, N., Prescher, G.; Schwind, H.; Weiberg, O.; Marten, K.; Greim, H. Acrylic Acid and Derivatives. In Ullman's Encyclopedia of Industrial Chemistry. Wiley-VCH Verlag GmbH & Co: Weinheim, 2012.
Roberts, I.; Urey, H. C. The Mechanisms of Acid Catalyzed Ester Hydrolysis, Esterification and Oxygen Exchange of Carboxylic Acids. J. Am. Chem. Soc. 1939, 61, 2584-2587.
Raber, D. J.; Gariano, P.; Brod, A. O.; Gariano, A.; Guida, W. C.; Guida, A. R.; Herbst, M. D. Esterification of Carboxylic Acids with Trialkyloxonium Salts. J. Org. Chem. 1979, 44, 1149-1154.
Liu, Y.; Lotero, E.; Goodwin, Jr, J. G. Effect of Water on Sulfuric Acid Catalyzed Esterification. J. Mol. Catal. A 2006, 245, 132-140.
Carlyle, R. L. Process for the Production of Acrylic Acid Esters. U.S. Pat. No. 2,917,538, Dec. 15, 1959.
Alarifi, A. S.; Aouak, T. Synthesis of Acrylic or Methacrylic Acid/Acrylate or Methacrylate Ester Polymers Using Pervaporation. U.S. Pat. No. 9,321,868 B2, Apr. 26, 2016.
McNeil, A. J.; Chazovachii, P. T.; Robo, M. T.; Marsh, N. G.; Zimmerman, P. M.; James, M. I.; Collias, D. I. Esterifying Polyacrylic Acid with High Conversion. U.S. Patent Application 62/947,363, Dec. 12, 2019; see also International PCT Patent Application Publication No. WO2021041326 for Super Absorbent Polymer Recycling to Pressure Sensitive Adhesives, to Collias et al., published Mar. 4, 2021.
Vilseck, J. Z.; Sohail, N.; Hayes, R. L.; Brooks, C. L. Overcoming Challenging Substituent Perturbations with Multisite X-Dynamics: A Case Study Targeting β-Secretase 1. J. Phys. Chem. Lett. 2019, 10, 4875-4880.
Hayes, R. L.; Armacost, K. A.; Vilseck, J. Z.; Brooks, C. L. Adaptive Landscape Flattening Accelerates Sampling of Alchemical Space in Multisite λ Dynamics. J. Phys. Chem. B 2017, 121, 3626-3635.
Chang, E. P. Viscoelastic Windows of Pressure-Sensitive Adhesives. J. Adhes. 1991, 34, 189-200.
Wernet, G.; Bauer, C.; Steubing, B.; Reinhard, J.; Moreno-Ruiz, E.; Weidema, B., The ecoinvent database version 3 (part I): overview and methodology. The International Journal of Life Cycle Assessment 2016, 21 (9), 1218-1230.
Arena, U.; Ardolino, F.; Gregorio, F. D., Technological, environmental and social aspects of a recycling process of post-consumer absorbent hygiene products. Journal of Cleaner Production 2016, 127, 289-301.
Khoo, S. C.; Phang, X. Y.; MinNg, C.; LokeLim, K.; Lam, S. S.; LingMa, N., Recent technologies for treatment and recycling of used disposable baby diapers. Process Safety and Environmental Protection 2019, 123, 116-129.
Christ, C. D.; Mark, A. E.; Van Gunsteren, W. F. Basic Ingredients of Free Energy Calculations: A Review. J. Comput. Chem. 2010, 31, 1569-1582.
Hanwell, M. D.; Curtis, D. E.; Lonie, D. C.; Vandermeerschd, T.; Zurek, E.; Hutchison, G. R. Avogadro: An Advanced Semantic Chemical Editor, Visualization, and Analysis Platform. J. Cheminform. 2012, 4, 17.
56 Martinez, L.; Andrade, R., Birgin, E. G.; Martinez, J. M. PACKMOL: A Package for Building Initial Configurations for Molecular Dynamics Simulations. J. Comput. Chem. 2009, 30 (13), 2157-2164.
Jorgensen, W. L.; Chandrasekhar, J.; Madura, J. D.; Impey, R. W.; Klein, M. L. Comparison of Simple Potential Functions for Simulating Liquid Water. J. Chem. Phys. 1983, 79, 926-935.
Vanommeslaeghe, K.; Hatcher, E.; Acharya, C.; Kundu, S.; Zhong, S.; Shim, J.; Darian, E.; Guvench, O.; Lopes, P.; Vorobyov, I.; Mackerell, A. D. CHARMM General Force Field: A Force Field for Drug-like Molecules Compatible with the CHARMM All-Atom Additive Biological Force Fields. J. Comput. Chem. 2009, 31, NA-NA.
Yesselman, J. D.; Price, D. J.; Knight, J. L.; Brooks, C. L. MATCH: An Atom-Typing Toolset for Molecular Mechanics Force Fields. J. Comput. Chem. 2012, 33, 189-202.
Brooks, B. R.; Brooks, C. L.; Mackerell, A. D.; Nilsson, L.; Petrella, R. J.; Roux, B.; Won, Y.; Archontis, G.; Bartels, C.; Boresch, S.; Caflisch, A.; Caves, L.; Cui, Q.; Dinner, A. R.; Feig, M.; Fischer, S.; Gao, J.; Hodoscek, M.; Im, W.; Kuczera, K.; Lazaridis, T.; Ma, J.; Ovchinnikov, V.; Paci, E.; Pastor, R. W.; Post, C. B.; Pu, J. Z.; Schaefer, M.; Tidor, B.; Venable, R. M.; Woodcock, H. L.; Wu, X.; Yang, W.; York, D. M.; Karplus, M. CHARMM: The Biomolecular Simulation Program. J. Comput. Chem. 2009, 30, 1545-1614.
Hynninen, A.-P.; Crowley, M. F. New Faster CHARMM Molecular Dynamics Engine. J. Comput. Chem. 2014, 35, 406-413.
Darden, T.; York, D.; Pedersen, L. Particle Mesh Ewald: An N-log(N) Method for Ewald Sums in Large Systems. J. Chem. Phys. 1993, 98), 10089-10092.
Essmann, U.; Perera, L.; Berkowitz, M. L.; Darden, T.; Lee, H.; Pedersen, L. G. A Smooth Particle Mesh Ewald Method. J. Chem. Phys. 1995, 103, 8577-8593.
Huang, Y.; Chen, W.; Wallace, J. A., Shen, J. All-Atom Continuous Constant PH Molecular Dynamics with Particle Mesh Ewald and Titratable Water. J. Chem. Theory Comput. 2016, 12, 5411-5421.
Shirts, M. R.; Chodera, J. D. Statistically Optimal Analysis of Samples from Multiple Equilibrium States. J. Chem. Phys. 2008, 129, 124105.
Vilseck, J. Z.; Sohail, N.; Hayes, R. L., Brooks, C. L. Overcoming Challenging Substituent Perturbations with Multisite X-Dynamics: A Case Study Targeting β-Secretase 1. J. Phys. Chem. Lett. 2019, 10, 4875-4880.
Hayes, R. L.; Armacost, K. A.; Vilseck, J. Z.; Brooks, C. L. Adaptive Landscape Flattening Accelerates Sampling of Alchemical Space in Multisite X Dynamics. J. Phys. Chem. B 2017, 121, 3626-3635.
Wernet, G.; Bauer, C.; Steubing, B.; Reinhard, J.; Moreno-Ruiz, E.; Weidema, B., The ecoinvent database version 3 (part I): overview and methodology. The International Journal of Life Cycle Assessment 2016, 21 (9), 1218-1230.
LCIA: the ReCiPe model.
Poulikidou, S.; Heyne, S.; Grahn, M.; Harvey, S., Lifecycle energy and greenhouse gas emissions analysis of biomass-based 2-ethylhexanol as an alternative transportation fuel. Energy Science & Engineering 2019, 7 (3), 851-867.
Itsubo, N.; Wada, M.; Imai, S.; Myoga, A.; Makino, N.; Shobatake, K., Life Cycle Assessment of the Closed-Loop Recycling of Used Disposable Diapers. Resources 2020, 9 (3), 34.
Prosapio, V.; Norton, I.; De Marco, I., Optimization of freeze-drying using a Life Cycle Assessment approach: Strawberries' case study. Journal of Cleaner Production 2017, 168, 1171-1179.
Hayashi, Y. Pot Economy and One-Pot Synthesis. Chem. Sci. 2016, 7(2), 866-880.

Although the foregoing subject matter has been described in some detail by way of illustration and example for purposes of clarity of understanding, it will be understood by those skilled in the art that certain changes and modifications can be practiced within the scope of the appended claims.

1. A method for converting a sodium polyacrylate to a pressure sensitive adhesive, the method comprising one of:
(i)
(a) acid-catalyzed decrosslinking the polyacrylate via hydrolysis to generate a linear polymer;
(b) optionally sonicating the linear polymer to lower a molar mass thereof; and
(c) functionalizing the linear polymer via esterification to generate a pressure sensitive adhesive; or
(ii)
(a) disposing an alkyl alcohol and a sodium polyacrylate into a reaction vessel to form a first reaction mixture;
(b) adding a protic solvent and an acid to the reaction vessel to form a second reaction mixture; and
(c) heating the second reaction mixture with stirring to form a polymer comprising a pressure sensitive adhesive.

2. The method of claim 1, wherein the sodium polyacrylate comprises a sodium poly(acrylate) crosslinked via a poly(ethylene glycol) diacrylate co-monomer.

3. (canceled)

4. The method of claim 1, wherein the acid-catalyzed decrosslinking via hydrolysis step (i)(a) includes contacting the sodium polyacrylate with H₂SO₄ under heating for a period of time.

5. The method of claim 1, wherein the linear polymer of (i)(b) is sonicated to a M_{w} of between about 300 kg/mol to about 400 kg/mol.

6. The method of claim 1, further comprising one or more of:
dialyzing the sonicated linear polymer;
lyophilizing the dialyzed linear polymer; and
grinding the lyophilized linear polymer.

7. (canceled)

8. (canceled)

9. The method of claim 1, wherein the functionalizing of the linear polymer via esterification of step (i)(c) includes contacting the polyacrylate with an alkyl alcohol in the presence of an acid catalyst.

10. The method of claim 9, wherein the alkyl alcohol is 2-ethylhexanol.

11. The method of claim 9, wherein the acid catalyst comprises H₂SO₄.

12. The method of claim 1, wherein the sodium polyacrylate is derived from a disposable personal hygiene product.

13. The method of claim 12, wherein the disposable personal hygiene product is selected from the group consisting of a baby diaper, an adult incontinence product, and a feminine hygiene product.

14. An article comprising the pressure sensitive adhesive formed by the method of claim 1.

15. The article of claim 14, wherein the article is selected from the group consisting of pressure sensitive tape, a bandage, a label, note pads, a decal, a stamp, an envelope, a sticker, packaging, automobile trim, and a film.

16. (canceled)

17. The method of claim 1, wherein step (ii)(a) and/or step (ii)(b) further comprises bubbling an inert gas through the first reaction mixture and/or the second reaction mixture for a period of time to remove oxygen from the reaction vessel.

18. The method of claim 17, wherein the inert gas comprises nitrogen.

19. The method of claim 1, wherein the protic solvent of step (ii)(b) is water or a hydrophilic alcohol.

20. The method of claim 19, wherein the hydrophilic alcohol is methanol or ethanol.

21. The method of claim 1, wherein the alkyl alcohol of step (ii)(a) is 2-ethylhexanol or butyl alcohol.

22. The method of claim 1, wherein step (ii) further comprises cooling the reaction vessel.

23. The method of claim 22, further comprising one or more of:
isolating the polymer comprising the pressure sensitive adhesive by precipitating into an alcohol;
centrifugation of the precipitate;
removing one or more byproducts; and
purifying by dissolving/swelling the polymer comprising the pressure sensitive adhesive in tetrahydrofuran (THF) and precipitating with methanol and drying under vacuum.

24. (canceled)

25. (canceled)

26. (canceled)

27. (canceled)

28. (canceled)

29. (canceled)

30. (canceled)

31. (canceled)
